(19) United States
(12) Patent Application Publication
(10) Pub. No.: US 2026/0234044 A1
(43) Pub. Date: Aug. 13, 2026

(54) SYSTEMS AND METHODS FOR GLASS TUBE SEPARATION AND SEALING USING LASERS

(71) Applicant: CORNING INCORPORATED, CORNING, NY (US)

(72) Inventors: Anatoli Anatolyevich Abramov, Painted Post, NY (US); Ian Michael Murphy, Woodbury, NJ (US)

(21) Appl. No.: 19/151,313

(22) PCT Filed: Jan. 17, 2024
(86) PCT No.: PCT/US2024/011766

§ 371 Date: Jul. 26, 2025

Related U.S. Application Data
(60) Provisional application No. 63/441,305, filed on Jan. 26, 2023.

(51) Int. Cl. C03B 23/13; C03B 23/043; C03B 33/06

(52) U.S. Cl. CPC C03B 23/13; C03B 23/043; C03B 33/06

(57) ABSTRACT

Systems for finishing ends of glass tubes or glass rods include a conveyor operable to translate and rotate the glass tubes or glass rods and a separating laser system comprising a laser source operable to produce a separating laser beam and a beam delivery system operable to modify a shape, power density, or power density distribution of the separating laser beam and direct the separating laser beam to the glass tubes or glass rods. Methods of cutting and finishing ends of the glass tubes or rods with the systems includes rotating each glass tube or rod about a center axis of the glass tube or rod, heating a target region of the glass tube or rod by exposing the target region to a separating laser beam while rotating the glass tube or rod, and applying a pulling force to the end of the glass tube or rod.

### CROSS-REFERENCE TO RELATED APPLICATIONS

This application claims the benefit of priority under 35 U.S.C. § 119 of U.S. Provisional Application Ser. No. 63/441,305 filed on Jan. 26, 2023, the content of which is relied upon and incorporated herein by reference in its entirety.

### BACKGROUND

### Field

The present specification generally relates to methods, apparatuses, and systems for continuously producing glass tubing and glass rods, in particular, methods, apparatuses, and systems for finishing ends of lengths of glass bars and glass tubes produced from a continuous hollow glass tube.

### Technical Background

Historically, glass has been used to produce a variety of articles. In particular, because of its hermeticity, optical clarity, and excellent chemical durability relative to other materials, glass has been a preferred material for pharmaceutical applications, including, without limitation, vials, syringes, ampoules, cartridges, jars, and other glass articles. Production of these articles from glass starts with providing glass tubing that may subsequently be formed and separated into a plurality of the glass articles. Specifically, the glass used in pharmaceutical packaging must have adequate mechanical and chemical durability so as to not affect the stability of the pharmaceutical formulations contained therein. Glasses having suitable chemical durability include those glass compositions within the ASTM standard ‘Type IA’ and ‘Type IB’ glass compositions which have a proven history of chemical durability.

The glass tubes used as the starting material for producing glass articles are produced from a continuous process, such as a Danner or Vello process, for producing a continuous hollow glass cylinder. The continuous hollow glass cylinder is annealed and cut into sections of glass tubes of roughly the same length by a high speed continuous cutter. Following the initial separation of the continuous hollow glass cylinder into a plurality of glass tubes, each of the glass tubes are further processed to finish the ends of the glass tubes, such as by cutting to length and polishing the ends to reduce breakage during shipping and handling. Glass rods can also be produced as a continuous solid glass cylinder from similar processes and then cut into rough length. The ends of glass rods are also further processed to finish he ends of the rods to cut to the final length and reduce breakage during shipping and handling.

### SUMMARY

Accordingly, a need exists for methods, apparatuses, and systems for continuously producing glass tubes or glass rods, in particular, for methods, apparatuses, and systems for continuously finishing the ends of lengths of glass tubes and glass rods.

According to one or more aspects of the present disclosure, a method for producing glass tubes may comprise producing a continuous hollow glass cylinder; cutting the continuous hollow glass cylinder into glass tubes having an initial length; and finishing at least one end of the plurality of glass tubes. Finishing the at least one end of the plurality of glass tubes may comprise rotating each glass tube about a center axis of the glass tube; while rotating the glass tube, heating a target region of the glass tube by exposing the target region of the glass tube to a separating laser beam; and while exposing the target region of the glass tube to the separating laser beam, applying a pulling force to the at least one end of the glass tube. Applying the pulling force while exposing the target region to the separating laser beam may separate a section of the glass tube from the at least one end of the glass tube and may finish a new end of the glass tube.

A second aspect may include the first aspect, wherein finishing the at least one end of the glass tube may reduce a length of the glass tube to a final length and may polish the new end of the glass tube in a single manufacturing step. A third aspect may include any of the previous aspects, wherein finishing the at least one end of the glass tube may produce the new end that is an open end of the glass tube, such as having an opening therethrough. A fourth aspect may include the first or second aspect, wherein finishing the at least one end of the glass tube may seal the new end of the glass tube to produce a sealed end of the glass tube. A fifth aspect may include any of the previous aspects, wherein new end of the glass tube may be substantially free of surface defects. A sixth aspect may include any of the previous aspects, wherein the new end of the glass tube may be substantially free of fused glass particles, hydrocarbon combustion products, or both.

A seventh aspect may include any of the previous aspects, wherein applying the pulling force to the at least one end of the glass tube may convey the section of the glass tube away from the glass tube in the axial direction relative to the center axis of the glass tube, which separates the section from the glass tube.

An eighth aspect may include any of the previous aspects, further comprising preheating the target region of each of the plurality of glass tubes, wherein preheating the target region of each of the plurality of glass tubes may comprise rotating each of the glass tubes and exposing each of the glass tubes to a preheating laser beam disposed upstream of the separating laser beam. A ninth aspect may include the eighth aspect, wherein the preheating laser beam may be separate from the separating laser beam.

A tenth aspect may include any of the previous aspects, comprising finishing a first end of each of the plurality of glass tubes with a first separating laser beam and finishing a second end of each of the plurality of glass tubes with a second separating laser beam. An eleventh aspect may include the tenth aspect, comprising finishing the first end and the second end of each of the plurality of glass tubes in parallel. A twelfth aspect may include the tenth aspect, further comprising finishing the second end with the second separating laser beam downstream of finishing the first end with the first separating laser beam.

A thirteenth aspect may include any of the previous aspects, wherein the separating laser beam may be an elongated beam, and the method may comprise exposing the target regions of a subset of the plurality of glass tubes to the separating laser beam simultaneously. A fourteenth aspect may include any of the previous aspects, wherein the separating laser beam may have a ratio of an overall length to a beam width of from about 5 to about 2000 at a point along a beam path where the separating laser beam falls incident on outer surfaces of the subset of the glass tubes. A fifteenth aspect may include either one of the thirteenth or fourteenth aspects, wherein exposing the target regions of the plurality of glass tubes to the separating laser beam may comprise conveying each of the plurality of glass tubes in succession through the elongated beam of the separation laser beam from a leading edge to a trailing edge of the separating laser beam. Conveying each of the plurality of glass tubes through the overall length of the major axis of the separating laser beam may heat the glass at the target region and separate the section from the at least one end of each of the plurality of glass tubes, and the overall length of the separating laser beam may be sufficient to contact each of the subset of glass tubes simultaneously. A sixteenth aspect may include the fifteenth aspect, wherein conveying each of the plurality of glass tubes in succession through the elongated beam may comprise arranging the plurality of glass tubes side-by-side on a conveyor comprising a plurality of rollers and at least one belt, wherein each glass tube may be disposed between two adjacent rollers of the conveyor, the plurality of rollers of the conveyor may rotate each of the plurality of glass tubes, and the at least one belt may move the rollers and the plurality of glass tubes horizontally through the elongated beam.

A seventeenth aspect may include any one of the previous aspects, wherein the separating laser beam may comprise an infrared laser. An eighteenth aspect may include any one of the previous aspects, wherein the separating laser beam may be a continuous laser beam or an alternating laser beam. A nineteenth aspect may include any one of the previous aspects, wherein the separating laser beam may comprise a laser power of from 200 W to 2000 W. A twentieth aspect may include any one of the previous aspects, wherein the separating laser beam may be an elliptical beam. A twenty-first aspect may include any one of the previous aspects, wherein the separating laser beam may be an elliptical laser beam having a ratio of a major axis to a minor axis of from about 5 to about 2000 at the point along a beam path where the separating laser beam falls incident on outer surfaces of the plurality of glass tubes. A twenty-second aspect may include any one of the previous aspects, wherein the separating laser beam may have a Gaussian power density distribution along a major axis of the separating laser beam. A twenty-third aspect may include any one of the previous aspects, wherein the separating laser beam may have a flat-top power density distribution along a major axis of the separating laser beam.

A twenty-fourth aspect may include any one of the previous aspects, wherein the separating laser beam may have a length of from about 100 mm to about 1000 mm, wherein the length of the separating laser beam may be the distance from a leading edge to a trailing edge of the separating laser beam at a point along a beam path where the separating laser beam falls incident on outer surfaces of the plurality of glass tubes. A twenty-fifth aspect may include any one of the previous aspects, wherein the separating laser beam may have a beam width of from about 0.5 mm to about 20 mm at a point along a beam path where the separating laser beam falls incident on outer surfaces of the plurality of glass tubes. A twenty-sixth aspect may include any one of the previous aspects, wherein the separating laser beam may have a beam width of from 0.5 mm to 5 mm at a point along a beam path where the separating laser beam falls incident on outer surfaces of the plurality of glass tubes, and exposing each of the plurality of glass tubes to the separating laser beam may remove the section of the at least one end of each glass tube to produce the new end comprising an opening. A twenty-seventh aspect may include any one of the first through twenty-fifth aspects, wherein the separating laser beam may have a beam width of from about 3 mm to 20 mm at a point along a beam path where the separating laser beam falls incident on outer surfaces of the plurality of glass tubes, and exposing each of the plurality of glass tubes to the separating laser beam may remove the section of the at least one end of each glass tube to produce the new end and seals the new end to produce a sealed end of the glass tube.

A twenty-eighth aspect may include any one of the previous aspects, further comprising: determining whether to finish the at least one end of the plurality of glass tubes to produce open or sealed new ends; and changing one or more of a beam shape, power, power density distribution, or combinations thereof of the separating laser beam, wherein: changing the beam shape, power, power density distribution, or combination thereof of the separating laser beam may change a volume of glass heated in the target regions of the plurality of glass tubes; decreasing the volume of glass heated in the target regions may produce the new end with an opening; and increasing the volume of glass heated in the target regions may produce a meniscus of glass that seals the new end when the section is removed from the at least one end of the plurality of glass tubes. A twenty-ninth aspect may include the twenty-eighth aspect, comprising transitioning from forming the new ends that are open to forming the new ends that are sealed, wherein the transitioning may comprise one or more of the following: increasing a beam width of the separating laser beam; increasing a power density of the separating laser beam; changing the power density distribution from a Gaussian distribution to a flat top distribution; or combinations thereof. A thirtieth aspect may include the twenty-ninth aspect, wherein the transitioning from forming the new ends that are open to forming the new ends that are sealed may comprise heating a volume of glass sufficient to form a meniscus of glass over the new end of the plurality of glass tubes when the section is removed from the at least one end of the plurality of glass tubes.

A thirty-first aspect may include any of the twenty-ninth or thirtieth aspects, comprising changing the beam shape of the separating laser beam by changing the beam width into a range of from 3 mm to 20 mm. A thirty-second aspect may include the thirty-first aspect, wherein changing the beam shape may comprise adjusting a spacing between lenses of a beam delivery system. A thirty-third aspect may include either one of the thirty-first or thirty-second aspects, wherein changing the beam shape may comprise passing the separating laser beam through a variable beam expander. A thirty-fourth aspect may include any of the thirty-first through thirty-third aspects, wherein changing the beam shape may comprise adjusting a distance between a beam delivery system and the plurality of glass tubes, which may change a point within a beam path where the separating laser beam contacts outer surfaces of the plurality of glass tubes relative to a waist of the separating laser beam.

A thirty-fifth aspect may include any one of the twenty-eighth through thirty-fourth aspect, further comprising changing the power density of the separating laser beam at a point along a beam path where the separating laser beam contacts outer surfaces of the plurality of glass tubes, wherein changing the power density of the separating laser beam may comprise adjusting a power of a laser source for producing the separating laser beam, changing a vertical distance between a beam delivery system and the plurality of glass tubes, or both.

A thirty-sixth aspect may include any of the previous aspects, further comprising changing a heating rate of the separating laser beam, wherein changing the heating rate of the separating laser beam may comprise changing the power density of the separating laser beam, changing the power density distribution of the separating laser beam, changing a speed of a conveyor that translates the plurality of glass tubes through the separating laser beam, or combinations thereof. A thirty-seventh aspect may include the thirty-sixth aspect, comprising changing the power density of the separating laser beam, wherein changing the power density of the separating laser beam may comprise adjusting a power of a laser source for producing the separating laser beam, changing a vertical distance between a beam delivery system and the plurality of glass tubes, or both. A thirty-eighth aspect may include either one of the thirty-sixth or thirty-seventh aspects, comprising changing the power density distribution of the separating laser beam, wherein changing the power density distribution may comprise passing the separating laser beam through a cylindrical lens to produce a Gaussian power density distribution having a lower heating rate or passing the separating laser beam through an aspheric-cylindrical lens to produce a flat-top power density distribution having a greater heating rate.

A thirty-ninth aspect may include any one of the previous aspects, further comprising: changing a type of glass tube from a first type to a second type by changing a glass composition, a nominal diameter, a thickness, or combinations thereof of the plurality of glass tubes; and changing the heating rate of the separating laser beam in response to the change in type of glass tube. A fortieth aspect may include the thirty-ninth aspect, wherein changing the heating rate may comprise changing the power density of the separating laser beam, changing the power density distribution of the separating laser beam, changing a speed of a conveyor that translates the plurality of glass tubes through the separating laser beam, or combinations thereof. A forty-first aspect may include either one of the thirty-ninth or fortieth aspects, wherein changing the heating rate does not require changing the lenses of a beam delivery system.

A forty-second aspect may include any one of the previous aspects, further comprising increasing a production rate of the glass tubes, wherein increasing the production rate of the glass tubes may comprise changing a speed of a conveyor that translates the plurality of glass tubes through a beam path of the separating laser beam and increasing a power density of the separating laser beam, changing a power density profile from a Gaussian power density profile to a flat-top power density profile, or both. A forty-third aspect may include the forty-second aspect, wherein increasing the production rate of the glass tubes further may comprise preheating the target regions of the plurality of glass tubes with a preheating laser system.

A forty-fourth aspect may include any one of the previous aspects, wherein target region of each glass tube may be within at least 100 mm from the at least one end of the glass tube. A forty-fifth aspect may include any one of the previous aspects, wherein the sections removed from the at least one end of the plurality of glass tubes may have a length of less than 100 mm. A forty-sixth aspect may include any one of the previous aspects, further comprising conveying the plurality of glass tubes horizontally while rotating the plurality of glass tubes and finishing the at least one end of each of the plurality of glass tubes. A forty-seventh aspect may include any one of the previous aspects, wherein exposing each of the plurality of glass tubes to the separating laser beam may comprise: producing a laser beam using a laser source; passing the laser beam through optics that shape the laser beam to produce the separating laser beam and direct the separating laser beam towards the plurality of glass tubes; and passing each of the plurality of glass tubes through a beam path of the separating laser beam.

A forty-eighth aspect may include any one of the previous aspects, wherein producing the continuous hollow glass cylinder may further comprise drawing the continuous hollow glass cylinder from a tube forming apparatus. A forty-ninth aspect may include any one of the previous aspects, wherein producing the continuous hollow glass cylinder may comprise: forming the continuous hollow glass cylinder from molten glass in a tube forming apparatus; pulling the continuous hollow glass cylinder from the tube forming apparatus through an annealing process; annealing the continuous hollow glass cylinder; cutting the continuous hollow glass cylinder to produce the plurality of glass tubes having an initial length; and transferring the plurality of glass tubes to a horizontal conveyor upstream of finishing the at least one end of the plurality of glass tubes.

A fiftieth aspect disclosed herein may comprise a system for finishing ends of a plurality of glass tubes or glass rods, the system comprising a conveyor operable to translate the plurality of glass tubes or glass rods horizontally while also rotating each of the plurality of glass tubes or glass rods about a center axis of the glass tube or glass rod and a separating laser system comprising: a laser source operable to produce a laser beam; and a beam delivery system operable to modify a shape, power density, power density distribution, or combinations thereof of the laser beam to produce a separating laser beam and direct the separating laser beam to the plurality of glass tubes or glass rods being translated and rotated by the conveyor. The system may further comprise one or more axial separation conveyors that may diverge from the conveyor and may be operable to exert a pulling force on an end of each of the plurality of glass tubes or glass rods in at least an axial direction relative to the center axis.

A fifty-first aspect may include the fiftieth aspect, wherein the beam delivery system may comprises one or more beam expansion optics, shaping optics, and turning mirrors. A fifty-second aspect may include either one of the fiftieth or fifty-first aspects, wherein the beam delivery system further may comprise one or more of variable beam expander, cylindrical lenses, aspheric-cylindrical lenses, polygon mirrors, or combinations thereof to control beam size, beam shape, beam power density distribution, or combinations thereof. A fifty-third aspect may include any one of the fiftieth through fifty-second aspects, wherein the beam delivery system may comprise at least one cylindrical lens operable to produce a separating laser beam with a Gaussian power density distribution. A fifty-fourth aspect may include any one of the fiftieth through fifty-third aspects, wherein the beam delivery system may comprise an aspheric-cylindrical lens operable to produce a beam having a flat-top power density distribution. A fifty-fifth aspect may include any one of the fiftieth through fifty-fourth aspects, wherein the beam delivery system comprises a variable beam expander.

A fifty-sixth aspect may include any one of the fiftieth through fifty-fifth aspects, further comprising a preheating laser system disposed upstream of the separating laser delivery system, wherein the preheating laser system may comprise a preheating laser source and a preheating beam delivery system and may be operable to direct a preheating laser beam at the target regions of the plurality of glass tubes or glass rods to preheat the glass in the target regions upstream of the separating laser beam.

A fifty-seventh aspect may include any one of the fiftieth through fifty-sixth aspects, wherein the separating laser system may comprise: a first separating laser system operable to direct a first separating laser beam to target regions proximate first ends of the plurality of glass tubes or glass rods; and a second separating laser system operable to direct a second separating laser beam to target regions proximate to second ends of the plurality of glass tubes or glass rods. A fifty-eighth aspect may include the fifty-seventh aspect, wherein the first separating laser system may comprise a first laser source and a first beam delivery system and the second separating laser system may comprise a second laser source and a second beam delivery system.

A fifty-ninth aspect may include either one of the fifty-seventh or fifty-eighth aspects, further comprising: a first preheating laser system disposed upstream of the first separating laser system; and a second preheating laser system disposed upstream of the second separating laser system, wherein each of the first preheating laser system and the second preheating laser system comprise a preheating laser source and a preheating beam delivery system.

A sixtieth aspect may include any one of the fiftieth through fifty-ninth aspects, further comprising a positioning system operatively coupled to the separating laser system, wherein the positioning system may be operable to change a distance between the separating laser system and the plurality of glass tubes or glass rods.

A sixty-first aspect may include any one of the fiftieth through sixtieth aspects, wherein the laser source may be an infrared laser. A sixty-second aspect may include any one of the fiftieth through sixty-first aspects, wherein the laser source may be a CO laser or a CO₂ laser. A sixty-third aspect may include any one of the fiftieth through sixty-second aspects, wherein the system does not include gas burners and does not include mechanical tools for scoring a surface of the plurality of glass tubes or glass rods.

A sixty-fourth aspect may include any one of the fiftieth through sixty-third aspects, wherein the conveyor may comprise a variable speed drive operatively coupled to one or more of the plurality of belts and operable to change a speed of the conveyor for translating the plurality of glass tubes or glass rods through a beam path of the separating laser beam. A sixty-fifth aspect may include any one of the fiftieth through sixty-fourth aspects, wherein the conveyor may comprise a plurality of rollers and a plurality of belts.

A sixty-sixth aspect may be directed to a method for producing glass rods, wherein the method may comprise: producing a continuous solid glass cylinder; cutting the continuous solid glass cylinder into glass rods having an initial length; finishing at least one end of the plurality of glass rods. Finishing the at least one end of the plurality of glass rods may comprise: rotating each glass rod about a center axis of the glass rod; while rotating the glass rod, heating a target region of the glass rod by exposing the target region of the glass rod to a separating laser beam; and while exposing the target region of the glass rod to the separating laser beam, applying a pulling force to the at least one end of the glass rod, wherein applying the pulling force while exposing the target region to the separating laser beam may separate a section of the glass rod from the at least one end of the glass rod and may finish a new end of the glass rod.

Additional features and advantages of the systems and methods disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a side view of a system for finishing at least one end of the plurality of glass tubes or glass rods, according to one or more embodiments shown and described herein;

FIG. 2 schematically depicts a side perspective view of a glass tube, according to one or more embodiments shown and described herein;

FIG. 3 schematically depicts a top view of a process for continuously producing glass tubes, according to one or more embodiments shown and described herein;

FIG. 4 schematically depicts a side elevation view of the process of FIG. 3 for continuously producing glass tubes, according to one or more embodiments shown and described herein;

FIG. 5 schematically depicts a top view of the system of FIG. 1 for finishing the ends of a plurality of glass tubes or glass rods, according to one or more embodiments shown and described herein;

FIG. 6 graphically depicts relative beam intensity (y-axis) as a function of beam position (x-axis) for elongated beams having Gaussian and flat-top power density profiles, according to one or more embodiments shown and described herein;

FIG. 7 schematically depicts another side elevation view of the system of FIG. 1 having a positioning system, according to one or more embodiments shown and described herein;

FIG. 8 schematically depicts a side perspective view of the system of FIG. 1 during operation of the system, according to one or more embodiments shown and described herein;

FIG. 9 schematically depicts a front view of a system for finishing both ends of glass tubes or glass rods, according to one or more embodiments shown and described herein;

FIG. 10 schematically depicts a side view of another system for finishing ends of the glass tubes or glass rods, the system having a separating laser system and a preheating laser system, according to one or more embodiments shown and described herein;

FIG. 11 is a photograph of ends of glass tubes separated using the system of FIG. 1, according to one or more embodiments shown and described herein; and

FIG. 12 is a photograph of ends of glass tubes separated and sealed using the system of FIG. 1, according to one or more embodiments shown and described herein.

### DESCRIPTION

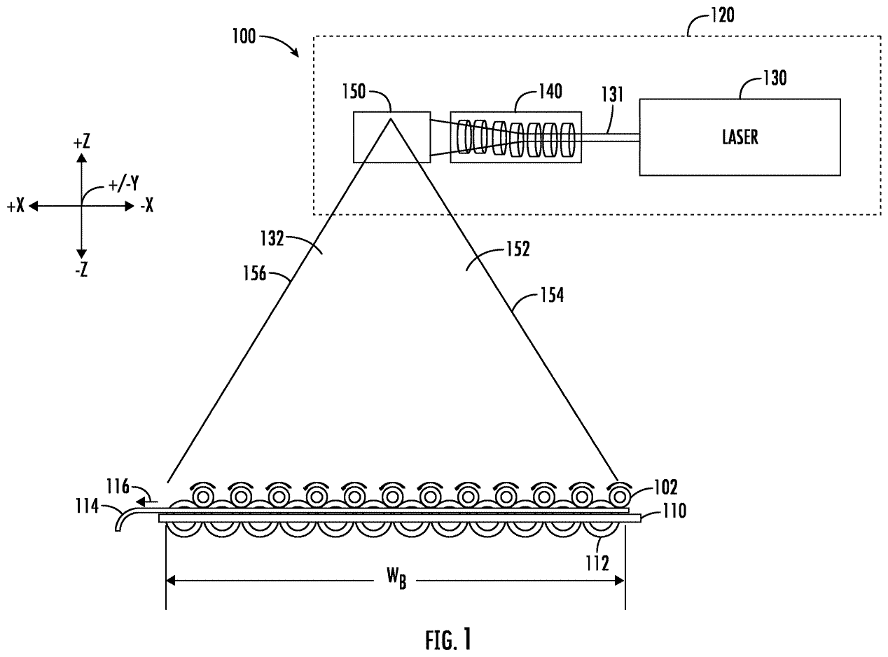

Reference will now be made in detail to embodiments of apparatuses, systems, and methods for continuously producing composite glass tubes or glass rods, examples of which are illustrated in the accompanying drawings. Whenever possible, the same reference numerals will be used throughout the drawings to refer to the same or like parts. Referring now to FIG. 1, systems 100 of the present disclosure for finishing one or both ends of glass tubes 102 or glass rods (not shown) may include a conveyor 110 operable to translate a plurality of glass tubes 102 or glass rods horizontally while also rotating each of the plurality of glass tubes 102 or glass rods about a center axis A of the glass tube 102 or glass rod. The systems 100 further include a separating laser system 120 comprising a laser source 130 operable to produce a separating laser beam 132 and a beam delivery system 140 operable to modify the shape and/or properties of the separating laser beam 132 and direct the separating laser beam 132 to the plurality of glass tubes 102 or glass rods as they are translated and rotated by the conveyor 110. The systems 100 may further include one or more axial separation conveyors 180 that diverge from the conveyor 110 and may be operable to exert a pulling force on an end of each of the plurality of glass tubes 102 or glass rods in at least an axial direction relative to the center axis A of each of the plurality of glass tubes 102 or glass rods.

The systems 100 disclosed herein can be used in methods of finishing the ends of the glass tubes 102 or glass rods. The methods for finishing ends of a glass tubes 102 or glass rods include rotating each glass tube 102 or glass rod about the center axis A; while rotating the glass tube 102 or glass rod, heating a target region of the glass tube 102 or glass rod by exposing the target region of the glass tube 102 or glass rod to a separating laser beam 132; and while exposing the target region of the glass tube 102 or glass rod to the separating laser beam 132, applying a pulling force to the at least one end of the glass tube 102 or glass rod, wherein applying the pulling force while exposing the target region to the separating laser beam may separate a section of the glass tube 102 or glass rod from the at least one end of the glass tube 102 or glass rod and finishes a new end of the glass tube 102 or glass rod. Methods disclosed herein for producing glass tubes 102 may include producing a continuous hollow glass cylinder, cutting the continuous hollow glass cylinder into the glass tubes 102 having an initial length, and then finishing at least one end of the glass tubes 102 according to any of the methods of finishing the ends of the glass tubes 102 disclosed herein. Methods disclosed herein for producing glass rods may include producing a continuous solid glass cylinder, cutting the continuous solid glass cylinder into the glass rods having an initial length, and then finishing at least one end of the glass rods according to any of the methods of finishing the ends of the glass tubes 102 or glass rods disclosed herein.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein-for example up, down, right, left, front, back, top, bottom—are made only with reference to the figures as drawn and the coordinate axis provided therewith and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, “axial” refers to a direction parallel to the center axis A of the glass tube or glass rod.

As used herein, the “beam waist” of a laser beam refers to the point along the beam path of the laser beam at which point the power density of the laser beam is greatest.

As used herein, the terms “upstream” and “downstream” refer to the positions of features of the glass tube of glass rod manufacturing process relative to a direction of travel of the glass tube through the manufacturing process. For instance, a first feature is “upstream” of a second feature if the glass tube encounters the first feature before encountering the second feature. Conversely, the first feature is “downstream” of the second feature if the glass tube encounters the second feature before encountering the first feature.

As used herein, the terms “upbeam” and “downbeam” refer to the positioning of two or more features of a system relative to the direction of travel of a laser beam along a beam pathway through the system. A first component may be considered to be upbeam of a second component if the laser beam encounters the first component before encountering the second component. Conversely, a first component may be considered to be downbeam of a second component when the laser beam encounters the second component before encountering the first component.

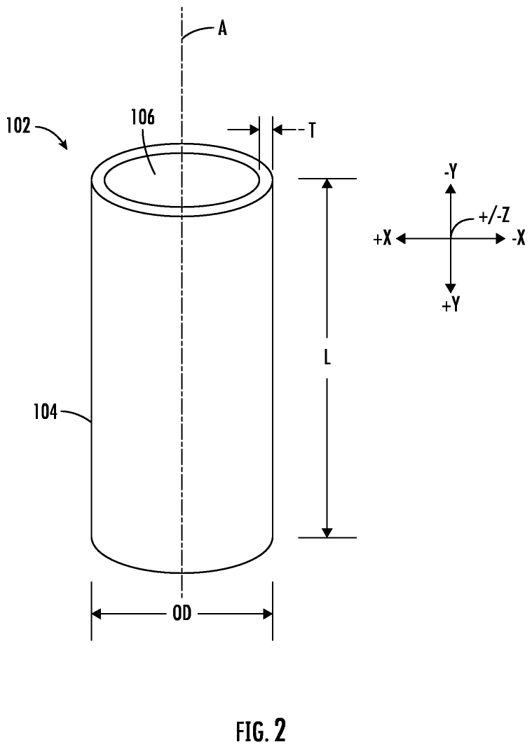

Because of its hermeticity, optical clarity, and excellent chemical durability relative to other materials, glass has been a preferred material for pharmaceutical applications, including, without limitation, vials, syringes, ampoules, cartridges, jars, and other glass articles. These pharmaceutical glass containers, as well as other types of glass articles, can be produced through a process of converting a length of glass tube to one or more of the glass articles through a plurality of heating and forming operations. Referring to FIG. 2, one embodiment of a glass tube 102 for use as the starting point for making a plurality of glass articles is schematically depicted. The glass tube 102 comprises a hollow cylinder of glass having an outer surface 104 and an inner surface 106. The inner surface 106 defines an interior of the glass tube 102. The glass tubes 102 have a first end 107 and a second end 108 opposite the first end. The glass tubes 102 are characterized by a tube length L, an outside diameter OD, and a thickness t. The tube length L is the distance from the first end 107 to the second end 108, and the thickness t refers to the average radial distance between the outer surface 104 and the inner surface 106 of the glass tube 102. The glass tube 102 further comprises a center axis A. Although described in the context of glass tubes 102, the methods of separating and end finishing can be applied with equal success to lengths of glass rods, which may also be used to produce a plurality of glass articles.

The subject matter disclosed herein relates to systems and methods for separation and end finishing of the glass tubes or glass rods during the production process for producing the glass tubes and glass rods. In production, molten glass is first formed into a continuous hollow glass cylinder using a glass tube forming process. Processes for forming molten glass into a continuous hollow glass cylinder can include the Danner process, the Vello process, or other current or future developed processes for producing continuous hollow glass cylinders. The continuous hollow glass cylinder is then pulled through an annealing process and then cut into individual glass tubes having an initial length.

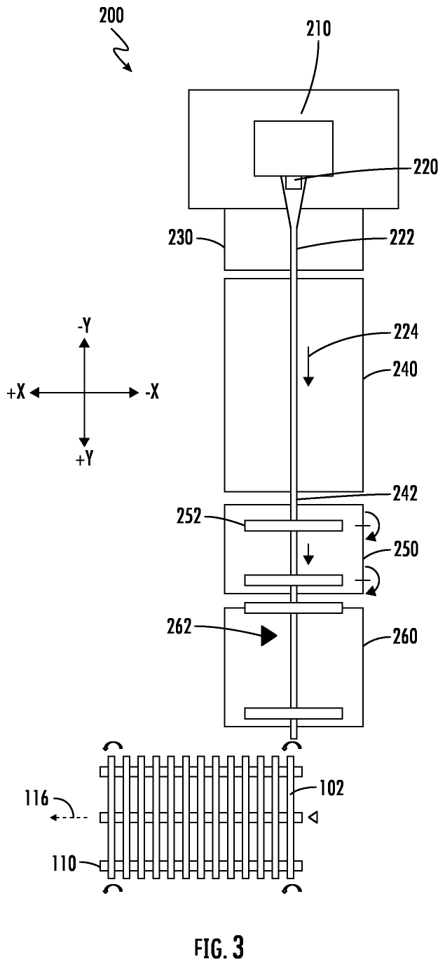

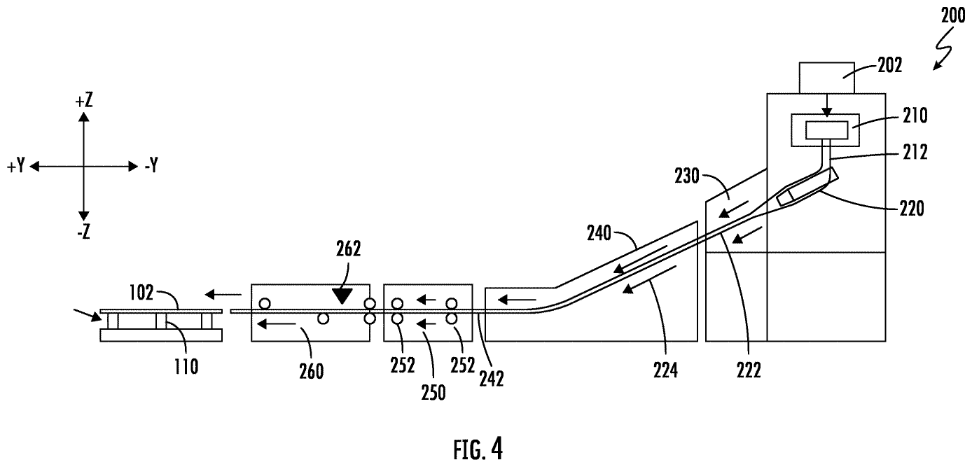

Referring now to FIGS. 3 and 4, one embodiment of a system 200 for producing a plurality of glass tubes 102 is schematically depicted. The system 200 may include a melt furnace 210, a glass tube forming apparatus 220 downstream of the melt furnace 210, a muffle furnace 230 downstream of the glass tube forming apparatus 220, an annealing section 240 downstream of the muffle furnace 230, a tube puller 250 downstream of the annealing section 240, a continuous tube cutter 260 downstream of the tube puller 250 and the horizontal conveyor 110 disposed downstream of the continuous tube cutter 260.

In operation of the system 200, a glass 202 is introduced to the melt furnace 210, which is operable to melt the glass to form a molten glass 212. The molten glass 212 is then passed to the glass tube forming apparatus 220, which is operable to form the molten glass 212 into a continuous hollow glass cylinder 222. As shown in FIG. 4, in embodiments, the glass tube forming apparatus 220 may be a tube forming apparatus used in the Danner process, in which the molten glass 212 runs from a feeder to a rotatable inclined hollow cylinder and is drawn off of the rotatable inclined hollow cylinder into the muffle furnace 230 by the tube puller 250 to produce the continuous hollow glass cylinder 222. While drawing the continuous hollow glass cylinder 222 off of the tube forming apparatus 220, compressed air or other gas supplied to the center of the continuous hollow glass cylinder 222 through the tube forming apparatus 220 along with the vacuum applied from the outside of the continuous hollow glass cylinder 222 help to control tube diameter and prevent the continuous hollow glass cylinder 222 from collapsing before cooling enough to retain its shape. Although shown as a Danner process in FIG. 4, it is understood that the continuous hollow glass cylinder 222 may be made using the Vello process or any other current or future process for making continuous hollow glass cylinders.

Referring again to FIGS. 3 and 4, after being formed, the continuous hollow glass cylinder 222 is then pulled through the muffle furnace 230 and the annealing section 240 by the tube puller 250. The annealing section 240 may be operable to anneal the continuous hollow glass cylinder 222 to produce an annealed continuous hollow glass cylinder 242. The tube puller 250 may include one or more sets of driven rollers 252 operable to exert a pulling force on the annealed continuous hollow glass cylinder 242 sufficient to pull it through the muffle furnace 230 and the annealing section 240. After passing the annealing section 240 and the tube puller 250, the annealed continuous hollow glass cylinder 242 passes to a tube cutter 260, where the annealed continuous hollow glass cylinder 242 is rough cut into glass tubes 102 having an initial length.

The process for making glass rods is similar to that for making glass tubes, except for the apparatus and method for drawing the glass rod from the melt furnace 210. Once the continuous solid glass rod is formed from the molten glass, the continuous solid glass rod is pulled through a muffle furnace and an annealing section by a rod puller. The annealed continuous solid glass cylinder is then continuously cut to rough length by a cutter to produce glass rods having an initial length.

Since the first cut performed by the tube cutter 260 or rod cutter is a rough cut, further processing of the glass tubes 102 or glass rods is conducted to cut the glass tubes 102 or glass rods to a final length and finish the ends of the glass tubes 102 or glass rods. Referring to FIG. 3, after the tube cutter 260, the glass tubes 102 are conveyed in a direction 116 perpendicular to the draw direction 242 for a second cut-to-length and edge finishing steps. In conventional tube manufacturing processes, the glass tubes 102 are cut to the final length in a second cut using a combination of mechanical tools for crack (scratch) initiation, heating by gas burners, and quenching the glass tubes 102 in order to create a thermal shock condition and to propagate the crack around the circumference of the glass tube 102 to complete separation of a section from the end of the glass tube 102. After the second cut is done at both ends, the edges at the ends of the glass tube are finished through fire polishing using the gas burners. The glass rods (not shown) may be processed in a similar manner to cut the glass rods to length and finish the ends. The conventional manufacturing processes for final cut-to-length and edge finishing is well established but presents a number of challenges and opportunities for improvement, especially considering the present increasing demand for pharmaceutical products and increasing focus on high quality, manufacturing efficiency, and environmental sustainability.

One of the challenges with the existing tube production or glass rod production processes is manufacturing throughput. Since the drawing speed of the continuous hollow glass cylinder or continuous solid glass cylinder is constantly increasing, especially for a thin-wall products, the cutting and finishing steps must enable high quality of the edges (no glass defects, acceptable geometry, high strength) and accurate final length of the tube or rod to achieve low loss and high yield at high processing speed. The existing cutting processes rely on creation of an initial scratch on the surface of the tube or rod performed by a cutting blade (or other mechanical tools) and on the subsequent propagation of the crack. The creation of a fracture surface, which is started from the initial mechanical defect and propagated around the circumference of the glass tube by a thermal stress, in not very accurate and requires several processing steps, which is not efficient. Additionally, separation is followed by edge fire polishing, which is needed to remediate surface flaws created by the score and break method. Edge or end fire polishing represents an additional process step and takes extra time to be completed, further reducing the efficiency of the manufacturing process.

Products in pharmaceutical packaging such as vials, cartridges, syringes, ampoules, or other containers, which are converted from glass tubing, require a high level of cleanliness. Mechanical initiation of the crack, which is used in the current conventional tube finishing processes, scratches the surface of the tube or rod, which generates glass particles that contaminate the outer surfaces and inner surfaces of the glass tubes or the surfaces of the glass rods. These glass particles then have to be removed from the glass tubes or glass rods through a thorough cleaning process. The cleaning process becomes more complicated if a large number of particles is generated during the manufacturing process, and especially, when glass particles adhere to the surface, such as by fusing to the glass surface during fire polishing of the edges of the glass tubes or glass rods.

In addition, the conventional manufacturing processes for finishing the ends the glass tubes or glass rods further contaminate the final product by exposing the surfaces of the glass product to unwanted elements due to contact with the glass, chemical reactions with the glass, and interaction with the combustion products from the gas burners. In particular, interactions of the glass with the combustion products from the gas burners used in thermal treatment and fire polishing can contaminate the surfaces of the glass final products (e. g, final tubes or rods). The combustion of fuels for the gas burners also creates a process exhaust containing combustion products that can have a negative impact on the environment.

Further, certain glass tube products require sealed tube ends. In conventional glass tube manufacturing processes, sealing the ends of the glass tubes is currently performed at the end of the conveyor line described above as an additional step done using gas burners after the final cut to length and edge polishing. The use of gas burners to seal the ends of the glass tubes add an additional manufacturing step, which reduces the efficiency of the manufacturing process, and further increases generation of combustion products, which can contaminate the surfaces of the glass tube and create additional process exhausts. Therefore, there is a need to improve current glass cutting and finishing processes to improve manufacturing efficiency and quality and reduce contamination and exhaust gases during manufacturing of glass tubes and glass rods.

The present application is directed to a new laser-based systems and methods for the separation and finishing the ends of glass tubes or glass rods using the laser-based methods and apparatus during glass tube or glass rod manufacturing. The systems of the present disclosure for finishing the ends of the glass tubes or glass rods include a conveyor operable to translate the plurality of glass tubes or glass rods horizontally while also rotating each of the plurality of glass tubes or glass rods about a center axis. The systems further include a separating laser system comprising a laser source operable to produce a separating laser beam and a beam delivery system operable to shape the separating laser beam and direct the separating laser beam to the plurality of glass tubes or glass rods being translated and rotated by the conveyor. The systems may further include one or more axial separation conveyors that diverge from the conveyor and are operable to exert a pulling force on an end of each of the plurality of glass tubes or glass rods in at least an axial direction relative to the center axis of each of the plurality of glass tubes or glass rods.

The laser-based methods disclosed herein for finishing ends of the glass tubes or glass rods include rotating each glass tube or glass rod about a center axis of the glass tube or glass rod; while rotating the glass tube or glass rod, heating a target region of the glass tube or glass rod by exposing the target region to a separating laser beam, which is produced by the separating laser system; and while exposing the target region of the glass tube or glass rod to the separating laser beam, applying a pulling force to the at least one end of the glass tube or glass rod. Applying the pulling force while exposing the target region to the separating laser beam separates a section of the glass tube or glass rod from the at least one end of the glass tube or glass rod and finishes a new end of the glass tube or glass rod.

The systems and methods disclosed herein can accomplish cutting of glass tubes and glass rods to produce finished new ends. The method enables a more stable, precise and controllable way of heat delivery to the glass due to a well-defined area affected by the separating laser beam and stability of the laser power over an extended period of time. Precise heating by the laser system can minimize variations of dimensions of the final parts, reduce the number of rejects and increase yield by tightly controlling glass viscosity. For glass tubes, the systems and methods can accomplish cutting the glass tube to produce new ends that are open ends, or in tube cutting accompanied by the sealing to produce new ends that are sealed. The systems and methods disclosed herein combine cutting and edge finishing into a one-step process. The systems and methods disclosed herein allow for performing glass tube separation and bottom forming at the same time. Further, the systems and methods disclosed herein can enable the beam characteristics (e.g., length, beam width, power density, etc.) to be switched between a tube separation and finishing mode to a tube separation and bottom forming mode without changing lenses of the beam delivery system.

Additionally, the design of the beam delivery systems for the separating laser beam, the preheating laser beam, or both creates an elongated laser beam, which enables continuous processing of multiple tubes or rods at the same time, which increases heating efficiency and reduces processing time. Heating of the tubes or rods by an elongated laser beam happens continuously without interruption as the glass tubes or rods are translated horizontally by the conveyor, which represents an advantage over discrete heating by a number of gas burners and enables faster conveyer speed. The heating rate of the glass tube or glass rod can be adjusted depending on the type and size of glass tube or glass rod by changing the power density and/or power density profile in the longitudinal direction of the separating laser beam. The systems and methods allow for adjustment of the beam characteristics (e.g., length, beam width, power density, etc.) of the separating laser beam in order to adjust the process for different glass types, diameters, and wall thickness of the glass tubes or glass rods. The systems and methods may further enable pre-heating of the target regions of the glass tubes or glass rods using an additional elongated laser beam (i.e., preheating laser beam), if needed, to accelerate separation and/or to process glass tube or glass rods with greater diameter or glass tubes with greater sidewall thickness.

Further, the systems and methods disclosed herein do not require mechanical initiation and quenching to create a thermal shock for crack propagation. Thus, the systems and methods disclosed herein may reduce contamination of the surfaces of the glass tubes or glass rods with fused glass particles. The systems and methods disclosed herein also do not use gases and do not generate combustion products, which reduces glass contamination from the gases and/or combustion products and improves the environmental footprint of the glass tube and glass rod forming and finishing processes.

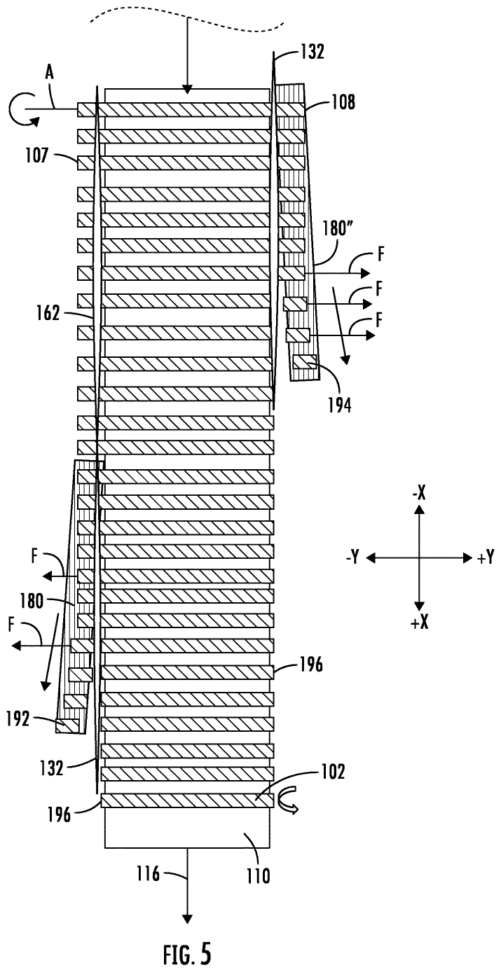

Referring again to FIG. 1, the systems 100 for cutting and finishing ends of a plurality of glass tubes 102 or glass rods comprises the conveyor 110, the separating laser system 120, and one or more axial separation conveyors 180 (shown in FIG. 5). The separating laser system 120 may comprise a laser source 130 operable to produce a laser beam 131 and a beam delivery system 140 operable to shape the laser beam 131 to produce a separating laser beam 132 and direct the separating laser beam 132 to the plurality of glass tubes 102 or glass rods being translated and rotated by the conveyor 110. For ease of illustration, the embodiments of the present disclosure will be described in the context of glass tubes. However, the systems and methods of the present disclosure can be applied to cutting and finishing the ends of glass rods with equal success.

In embodiments, the conveyor 110 may comprise a plurality of rollers 112 and a plurality of belts 114. The conveyor 110 may be operable to translate the plurality of glass tubes 102 horizontally (i. e, in the +X direction of the coordinate axis in FIG. 1) while also rotating each of the glass tubes 102 about a center axis A of the glass tubes 102. The plurality of rollers 112 may be arranged side-by-side in the +/−X direction of the coordinate axis in FIG. 1. In embodiments, the rollers 112 and may extend axially in the +/−Y direction, which may be parallel to the center axis A of the glass tubes 102. The rollers 112 may be rotatable in the same rotational direction. Each of the glass tubes 102, after being cut to the initial length by the tube cutter 160 (FIG. 3), may be positioned in a converging gap between two adjacent rollers 112 and supported through contact with the adjacent rollers 112. Contact of the outer surface 104 of the glass tubes 102 with the surfaces of the rollers 112, while the rollers 112 are rotated, may rotate the glass tubes 102 about the center axis A of the glass tubes 102.

The plurality of belts 114 may be operatively coupled to a drive motor (not show), which may cause the belts 114 to move along a belt path. The belts 114 may contact a portion of the rollers 112 such that, as the belts 114 are moved along the belt path, contact between the belts 114 and the rollers 112 may translate the rollers 112 and the glass tubes 102 disposed between each of the rollers 112 horizontally (i.e., in the +X direction of the coordinate axis of FIG. 1). Contact of one or more of the belts 114 with the rollers 112 may further cause rotation of the rollers 112 to facilitate rotation of the glass tubes 102. In embodiments, the drive motor operatively coupled to the belts 114 may be a variable speed drive which may be operable to change a speed of the conveyor 110 for translating the plurality of glass tubes 102 horizontally through a beam path of the separating laser beam 132. Although described as having a plurality of rollers 112 and belts 114, it is understood that the conveyor 110 can have other configurations, as long as the conveyor is operable to translate the glass tubes 102 horizontally while at the same time rotating the glass tubes 102 about the center axis A of each glass tube.

The system 100 includes one or more devices operable to exert a pulling force on an end of each of the glass tubes in at least an axial direction relative to the center axis A of each of the plurality of glass tubes. Referring now to FIG. 5, in embodiments, the system 100 may include one or more axial separation conveyors 180. The axial separation conveyors 180 may gradually diverge from the conveyor 110 in the longitudinal direction (i.e., cross machine direction or the +Y or −Y direction in the coordinate axis in FIG. 5). In embodiments, the axial separation conveyors 180 may comprise a plurality of rollers, and the ends of each of the glass tubes 102 may be disposed in the gap between adjacent rollers and supported by the adjacent rollers. The axial separation conveyors 180 may also have a plurality of belts (not shown) and a drive motor (not shown) for driving the axial separation conveyors 180. The axial separation conveyors 180 may be operable to exert a pulling force on an end of each of the glass tubes 102 in at least an axial direction relative to the center axis A of each of the plurality of glass tubes 102. The system 100 may comprise a first axial separation conveyor 180 on one side of the conveyor 110 and a second axial separation conveyor 180′ of the other side of the conveyor 110. The first axial separation conveyor 180 may exert a pulling force F on the first end 107 of the glass tubes 102, which may aid in separating a first section 192 from the first end 107 of the glass tubes during finishing of the glass tubes 102. The second axial separation conveyor 180′ may exert a pulling force F on the second end 108 of the glass tubes 102, which may aid in separating a second section 194 from the second end 108 of the glass tubes 102 during finishing of the glass tubes 102. Methods or apparatus other than an axial separation conveyor 180 may also be used in place of or in addition to an axial separation conveyor 180 to produce the pulling force F on the end of the glass tube.

Referring again to FIG. 1, the separating laser system 120 may comprise the laser source 130 and the beam delivery system 140 disposed downbeam from the laser source 130. The beam delivery system 140 refers to the collection of optical components (e.g., lenses, mirrors, filters, etc.) that modify one or more characteristics (e.g., shape, power density, power density distribution, etc.) of the laser beam 131 to produce the separating laser beam 132 and direct the separating laser beam 132 to the glass tubes 102. The laser source 130 may be operable to produce the laser beam 131. The laser beam 131, and the separating laser beam 132 produced therefrom, may have a wavelength in a wavelength range that allows the separating laser beam 132 to be absorbed by the glass of the glass tubes 102 to heat the glass and does not pass through the glass to a great extent. Because silicate-based glasses have strong absorption of light having wavelengths greater than or equal to about 4 micrometers (μm), many different laser sources can be used to produce the laser beam 131. The laser source 130 may be operable to produce the laser beam 131 having a wavelength in the infrared wavelength region, such as the far infrared region. The laser source 130 may be operable to produce the laser beam 131 having a wavelength of greater than or equal to about 1 μm, greater than or equal to about 2 μm, greater than or equal to about 3 μm, greater than or equal to about 4 μm, or even greater than or equal to about 8 μm. The laser source 130 may be operable to produce the laser beam 131 having a wavelength of less than or equal to about 12 μm, or even less than or equal to about 11 μm. The laser source 130 may be operable to produce the laser beam 131 having a wavelength of from about 1 μm to about 12 μm, from about 1 μm to about 11 μm, from about 2 μm to about 12 μm, from about 2 μm to about 11 μm, from about 3 μm to about 12 μm, from about 3 μm to about 11 μm, from about 4 μm to about 12 μm, from about 4 μm to about 11 μm, from about 5 μm to about 12 μm, from about 5 μm to about 11 μm, from about 8 μm to about 12 μm, or from about 8 μm to about 11 μm. The specific wavelength range may depend in part on the type of glass composition comprising the glass tubes.

The laser source 130 may be operable to produce the laser beam 131 that is an infrared laser beam. In embodiments, the laser source 130 may be a CO laser, a CO₂ laser, a quantum cascade laser (QCL), or other type of suitable laser capable of producing the laser beam 131 having a wavelength in the above range. The laser source 130 may be operable to produce the laser beam 131 that is continuous or pulsed. Continuous lasers generally have lower peak power and raise the glass surface temperature gradually, while pulsed lasers generally have high peak power and raise glass surface temperature to a greater degree in the shorter period of time compared to continuous lasers. The laser beam 131 may be collimated or un-collimated.

Referring again to FIG. 1, the beam delivery system 140 may be positioned downbeam from the laser source 130. The beam delivery system 140 may be operable to modify the characteristics of the laser beam 131, such as shape, power density distribution, other beam characteristics, or combinations thereof to produce the separating laser beam 132. The beam delivery system 140 may be further operable to direct the separating laser beam 132 to the plurality of glass tubes 102 as the glass tubes 102 are being translated horizontally and rotated by the conveyor 110. The beam delivery system 140 may comprise one or more beam expansion optics, shaping optics, turning mirrors 150, or combinations of these. In embodiments, the beam delivery system 140 may comprise at least one expansion optic, at least one shaping optic, and at least one turning mirror 150.

The expansion optics, the shaping optics, or both may include one or more lenses, mirrors, or both that are operable to expand the laser beam 131, shape the laser beam 131 into an elongated laser beam, or both to produce the separating laser beam 132. The laser beam 131 produced by the laser source 130 may be a round Gaussian laser beam. The beam delivery system 140 may include optical components that transform the round shape of laser beam 131 to an elliptical beam, change the dimensions (e.g., length and width) of the laser beam 131, and/or change the power density distribution along one or both axis of the elliptical beam to produce the separating laser beam 132. In embodiments, the beam delivery system 140 may comprise one or more variable beam expanders (e.g., zoom telescope lenses), cylindrical lenses, aspheric-cylindrical lenses, polygon mirrors, or combinations thereof to modify beam size, beam shape, beam power density distribution, or combinations thereof. In embodiments, the beam delivery system 140 may comprise one or more zoom telescope lenses or other variable beam expanders, which may be operable to modify the beam size, such as by increasing the beam size, of the laser beam 131 to produce the separating laser beam 132. In embodiments, the beam delivery system 140 may comprise one or more cylindrical lenses, which may be operable to modify the shape of the laser beam 131, such as modifying the length, beam width, or both of the laser beam 131 to produce the separating laser beam 132. In embodiments, the beam delivery system 140 may comprise a plurality of cylindrical lenses operable to transition the round laser beam 131 to the separating laser beam 132 having an elliptical shape. The plurality of cylindrical lenses may also expand or compress the laser beam 131 to produce the separating laser beam 132 having the target dimensions (e.g., length and beam width) at the point where the separating laser beam 132 contacts the glass tubes 102.

In embodiments, the beam delivery system 140 may include one or more lenses operable to change the power density distribution of the laser beam 131 to produce the separating laser beam 132. In embodiments, the beam delivery system 140 may include one or more spherical cylindrical lenses operable to produce a separating laser beam 132 having a Gaussian power density distribution. In embodiments, the beam delivery system 140 may comprise one or more aspheric-cylindrical lenses operable to produce a separating laser beam 132 having a flat-top power density distribution. In embodiments, the beam delivery system 140 may include one or more polygon mirrors, which may be operable to modify the power density distribution of the laser beam 131 to produce the separating laser beam 132. In embodiments, the separating laser beam 132 is an elliptical beam and the cylindrical lens, aspheric-cylindrical lens, or polygon mirror may be configured to modify the power density distribution in the direction of the major axis (i.e., in the longitudinal direction, such as the +/−X direction of the coordinate axis in FIG. 1).

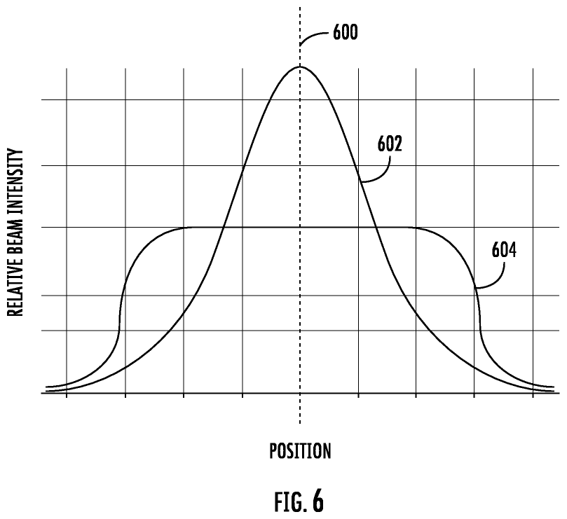

Referring now to FIG. 6, the power densities (y-axis) as a function of position in the beam (x-axis) for two different power density distributions of the separating laser beam 132 are graphically depicted. The position in the beam in FIG. 6 refers to the position in beam in the longitudinal direction (i.e., in a direction along the major axis of an elliptical beam, such as in the +/−X direction of the coordinate axis in FIG. 1). As shown in FIG. 6, a Gaussian power density distribution 602 is characterized by a maximum laser power density at the center 600 of the separating laser beam 132 and decreasing power density with increasing distances from the center 600 of the separating laser beam 132. In contrast, the flat-top power density distribution 604 has a smaller maximum power density but the power density is more uniform over the majority of the major axis of the laser beam.

The beam delivery system 140 may include any other optical components, such as but not limited to mirrors, lenses, prisms, filters, apertures, etc., operable to modify one or more characteristics of the laser beam 131 to produce the separating laser beam 132 upbeam of the point where the separating laser beam 132 is incident on the glass tubes 102. The beam delivery system 140 may provide for adjustment of the distance between the various components (e.g., lenses, mirrors, filters, prisms, etc.), within limits. Some adjustment of the distance between the optical components of the beam delivery system 140 may enable fine tuning of the dimensions and position of the separating laser beam 132 at the point where the separating laser beam 132 contacts the glass tubes 102. In embodiments, the length and beam width of the separating laser beam 132 can be modified by changing the distances between lenses in the beam delivery system 140.

Referring again to FIG. 1, in embodiments, the separating laser system 120 may be mounted horizontally (i.e., generally parallel to the X-Y plane of the coordinate axis in FIG. 1) above the conveyor 110, and the beam delivery system 140 may include a turning mirror 150. The turning mirror 150 may be operable to turn the separating laser beam 132 downward (i.e., in the-Z direction) towards the glass tubes 102 on the conveyor 110. Although shown herein as being mounted horizontally above the conveyor 110, it is understood that the separating laser system 120 may be mounted in any suitable position and one or a plurality of turning mirrors 150 may be utilized to direct the separating laser beam 132 to the glass tubes 102.

The separating laser beam 132 may be an infrared laser beam having a wavelength of from 1 μm to 12 μm, from 1 μm to 10 μm, from 2 μm to 12 μm, from 2 μm to 10 μm, from 3 μm to 12 μm, from 3 μm to 10 μm, from 4 μm to 12 μm, from 4 μm to 10 μm, from 8 μm to 12 μm, or from 8 μm to 10 μm. The separating laser beam 132 may be a continuous laser beam or an alternating laser beam. The separating laser beam 132 may have an overall laser power of greater than or equal to 200 watts (W), greater than or equal to 500 W, or even greater than or equal to 1000 W. In embodiments, the separating laser beam 132 may have an overall laser power of from 200 W to 2000 W, such as from 200 W to 1000 W, from 500 W to 2000 W, from 500 W to 1000 W, or from 1000 W to 2000 W.

The separating laser beam 132 may be characterized by a power density distribution. In embodiments, the separating laser beam 132 produced by the beam delivery system 140 may have a Gaussian power density distribution along the major axis (e.g., length) of the separating laser beam 132. In embodiments, the separating laser beam 132 produced by the beam delivery system 140 may have a flat-top power density distribution along the major axis (e.g., length) of the separating laser beam 132.

In embodiments, the separating laser beam 132 may be an elliptical beam having a major axis and a minor axis. The beam delivery system 140 may shape and direct the separating laser beam 132 so that the major axis of the separating laser beam 132 may be generally parallel to the machine direction of the conveyor 110 (i.e., +/−X direction of the coordinate axis of FIG. 1), and the minor axis of the separating laser beam 132 may be generally parallel to the cross-machine direction of the conveyor 110 (e.g., the +/−Y direction of the coordinate axis of FIG. 1). In embodiments, the separating laser beam 132 may be an elongated elliptical beam having the major axis greater than or equal to 5 times the minor axis at the point along the beam path where the separating laser beam 132 falls incident on the outer surfaces of the glass tubes 102. In embodiments, the separating laser beam 132 may be an elliptical laser beam having a ratio of the major axis to the minor axis of from about 5 to about 2000 at the point along the beam path where the separating laser beam 132 falls incident on outer surfaces of the plurality of glass tubes. When the separating laser beam 132 is an elongated elliptical beam, the separating laser beam 132 may be able to continuously contact and heat multiple glass tubes 102 at the same time to increase heating efficiency and reduce processing time of the end cutting and finishing process.

In embodiments, the separating laser beam 132 may have a length of from about 100 mm to about 1000 mm, wherein the length of the separating laser beam 132 refers to a distance from a leading edge 154 to a trailing edge 156 of the separating laser beam 132 at a point along a beam path where the separating laser beam 132 falls incident on the outer surfaces of the glass tubes 102. As used herein, the length of the separating laser beam 132 refers to the maximum distance between the leading edge 154 and the trailing edge 156 at the point rather than an average of the length taken over the beam width. For an elliptical beam, the beam length is equal to the length of the major axis of the elliptical beam. The upper limit on the length of the separating laser beam 132 may depend on the maximum available laser power. When the separating laser beam 132 is an elliptical beam, the length of the separating laser beam 132 may be equal to the distance across the separating laser beam 132 in a direction parallel to the major axis of the separating laser beam 132.

The separating laser beam 132 may have a beam width of from about 0.5 mm to about 20 mm at the point along the beam path where the separating laser beam 132 falls incident on the outer surfaces of the glass tubes 102. The beam width refers to the maximum width of the beam along the length of the beam. For an elliptical beam, the beam width is equal to the minor axis of the elliptical beam. In embodiments, the separating laser beam may have a beam width of from 0.5 mm to 10 mm, from 0.5 mm to 7 mm, from 0.5 mm to 5 mm, from 0.5 mm to 3 mm, from 0.5 mm to 2 mm, from 1 mm to 20 mm, from 1 mm to 10 mm, from 1 mm to 7 mm, from 1 mm to 5 mm, from 1 mm to 3 mm, from 1 mm to 2 mm, from 2 mm to 20 mm, from 2 mm to 10 mm, from 2 mm to 7 mm, from 2 mm to 5 mm, from 2 mm to 3 mm, from 3 mm to 20 mm, from 3 mm to 10 mm, from 3 mm to 7 mm, from 3 mm to 5 mm, from 5 mm to 20 mm, from 5 mm to 10 mm, from 5 mm to 7 mm, from 7 mm to 20 mm, from 7 mm to 10 mm, or even from 10 mm to 20 mm at the point along the beam path where the separating laser beam 132 falls incident on the outer surfaces of the glass tubes 102. The beam width of the separating laser beam 132 may be adjusted based on the thickness, diameter, glass composition or combinations thereof of the glass tubes 102.

The beam width of the separating laser beam 132 may also be selected depending on whether the end finishing includes sealing the new end of the glass tube 102 or providing a new end of the glass tube 102 that is open. In embodiments, finishing the ends of the glass tubes 102 may include providing a new end that is open, and the separating laser beam 132 may have a beam width of from 0.5 mm to 5 mm, such as from 0.5 mm to 3 mm, from 0.5 mm to 2 mm, from 1 mm to 5 mm, from 1 mm to 3 mm, or even from 1 mm to 2 mm, at the point along the beam path where the separating laser beam 132 falls incident on outer surfaces of the glass tubes 102. Exposing each of the glass tubes 102 to the separating laser beam 132 having the narrower beam width removes the section of the glass tube from the end of the glass tube 102 to produce the new end comprising an opening. The narrower beam width of the separating laser beam 132 in the range of from 0.5 mm to 5 mm may result in heating a volume of glass in the target region is not sufficient to form a meniscus of glass over the new end of the glass tubes 102.

In embodiments, finishing the ends of the glass tubes 102 may include sealing the ends of the glass tubes 102 to produce a sealed or closed end. To seal the ends of the glass tubes 102, an additional volume of glass is heated so that when the pulling force is applied to the end of the glass tube 102 to separate the section from the end of the glass tube 102, the greater volume of heated glass is sufficient to form a meniscus of glass covering the end of the glass tube 102. A greater volume of glass can be heated in the target region of the glass tube 102 by increasing the beam width of the separating laser beam 132. In embodiments, finishing the ends of the glass tubes 102 may include sealing the ends of the glass tubes 102, and the separating laser beam 132 may have a beam width of from about 3 mm to about 20 mm, such as from 3 mm to 10 mm, from 5 mm to 20 mm, from 5 mm to 10 mm, from 7 mm to 20 mm, from 7 mm to 10 mm, or even from 10 mm to 20 mm, at a point along the beam path where the separating laser beam 132 falls incident on the outer surfaces of the glass tubes 102. With the greater beam width, exposing each of the glass tubes 102 to the separating laser beam 132 having the greater beam width may remove the section of glass from the end of each glass tube 102 to produce the new end and may seal the new end to produce a sealed end of the glass tube 102. The range of beam widths of the separating laser beam 132 sufficient to heat a volume of glass that is enough to form a meniscus may depend on the thickness, diameter, and glass type of the glass tube. Increasing the beam width of the separating laser beam 132 may increase the volume of glass heated in the target region, which may result in a thicker meniscus formed over the end of the glass tube 102. Thus, the thickness of the sealed new end of the glass tube 102 can be modified by changing the beam width of the separating laser beam 132. The beam width and beam length of the separating laser beam 132 may be increased or decreased by changing the distances between two or more lenses of the beam delivery system 140, by changing a distance between the separating laser system 120 and the glass tubes 102, or both. Thus, the length and beam width of the separating laser beam 132 at the point where the separating laser beam 132 contacts the glass tubes 102 can be modified without changing lenses of the beam delivery system 140.

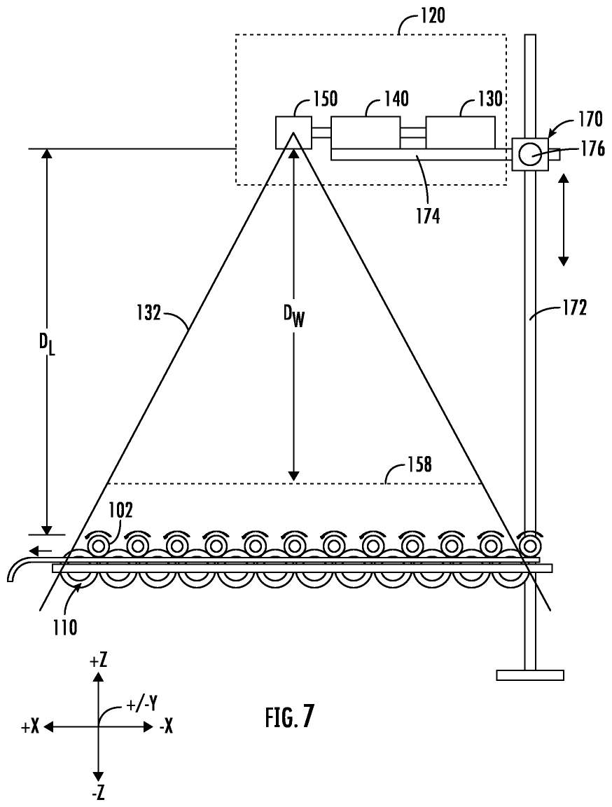

Referring now to FIG. 7, in embodiments, the system 100 may further include a positioner 170 operatively coupled to the separating laser system 120. The positioner 170 may be operable to change a distance between the separating laser system 120 and the glass tubes 102 supported on the conveyor 110. In embodiments, the positioner 170 may be operable to change the vertical distance D_{L} between the turning mirror 150 and the outer surface of the glass tubes 102. In embodiments, the positioner 170 may include at least one rail 172, a laser support 174 coupled to the laser system 120, and an actuator 176 movably securing the laser support 174 to the rail 172. The actuator 176 may be operable to translate the laser support 174 and laser system 120 along the rail 172 in the +/−Z direction of the coordinate axis in FIG. 7. The actuator 176 may be a stepper motor or other device operable to move the laser support 174 along the rail 172 in the +/−Z direction of the coordinate axis in FIG. 7. Although depicted in FIG. 7 as having a rail 172, laser support 174, and actuator 176, it is understood that the positioner 170 may include any other type of apparatus, such as hydraulic or pneumatic positioners, scissor lifts, pulleys, or other devices or combinations of devices suitable for moving the separating laser system 120 relative to the glass tubes 102. In embodiments, the positioner 170 may be manually adjusted to change the position of the laser support 174.

In embodiments, the positioner 170 may be operable to position the separating laser system 120 relative to the glass tubes 102 so that the glass tubes 102 are located in the center of the beam waist 158 of the separating laser beam 132. The beam waist 158 refers to the region of the beam path of the separating laser beam 132 at which the power density of the separating laser beam 132 is the greatest. In embodiments, the positioner 170 may be adjusted to position the separating laser system 120 so that the glass tubes 102 are disposed in converging or diverging sections of the separating laser beam 132 to reduce the power density of the separating laser beam 132. Changing the position of the separating laser system 120 to move the beam waist 158 closer to the glass tubes 102 may increase the power density of the separating laser beam 132 at the point where the separating laser beam 132 contacts the glass tubes 102. Conversely, changing the position of the separating laser system 120 to move the beam waist 158 further away from the glass tubes 102 may decrease the power density of the separating laser beam 132 at the point where the separating laser beam 132 contacts the glass tubes 102.

Additionally, moving the position of the separating laser system 120 to change the distance between the separating laser system 120 and the glass tubes 102 may also change the beam size. For instance, changing the distance between the separating laser system 120 and the glass tubes 102 to move the beam waist 158 of the separating laser beam 132 further away from the glass tubes 102 (e.g., positioning the glass tubes 102 further into the converging or diverging portions of the beam path) may result in the separating laser beam 132 having a greater beam width and length at the point in the beam path where the separating laser beam 132 falls incident on the outer surfaces of the glass tubes 102. Conversely, changing the distance between the separating laser system 120 and the glass tubes 102 to move the waist 158 of the separating laser beam 132 closer to the glass tubes 102 may result in the separating laser beam 132 having a reduced beam width and length of the separating laser beam 132 at the point in the beam path where the separating laser beam 132 falls incident on the outer surfaces of the glass tubes 102.

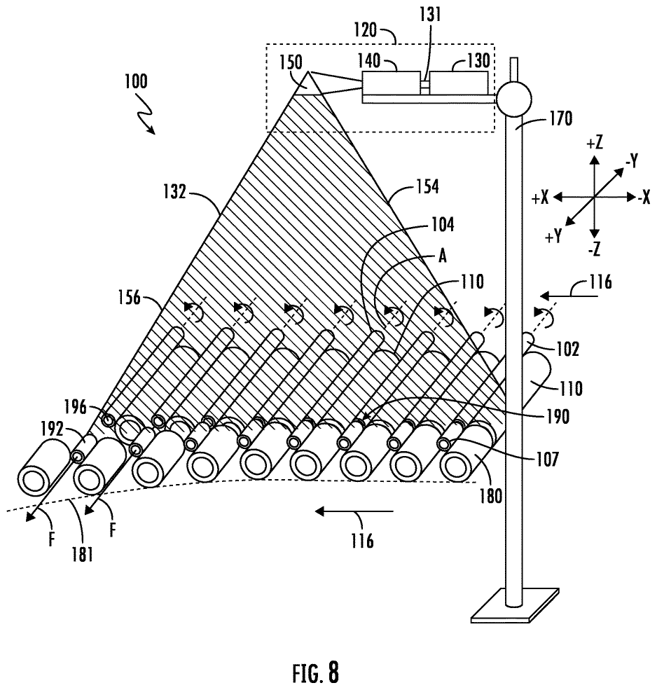

Referring now to FIG. 8, operation the system 100 for finishing a first end 107 of the glass tube 102 will now be described in further detail. The separating laser system 120 may be horizontally positioned (i.e., in the +/−Y direction of the coordinate axis in FIG. 8) so that the separating laser beam 132 is incident on the outer surface 104 of the glass tubes 102 at the target region 190 of the glass tubes 102. The target region 190 of the glass tubes 102 may be proximate the end of the glass tubes 102, such as proximate the first end 107 of the glass tubes 102, as shown in FIG. 8. In embodiments, the target region 190 of each glass tube 102 may be within at least 100 mm from the end of the glass tube 102, such as the first end 107 of the glass tube 102 in FIG. 8. As previously discussed, the separating laser system 120 may be vertically positioned (i.e., positioned in the +/−Z direction) to provide the desired shape and power density of the separating laser beam 132 at the point along the beam path where the separating laser beam 132 is incident on the target region 190 of the glass tubes 102.

During operation of the system, the conveyor 110 may translate the plurality glass tubes 102 in the machine direction 116 (i.e., in the +X direction of the coordinate axis in FIG. 8) while rotating the glass tubes 102 about the center axis A of the glass tubes 102. Translation of the glass tubes 102 in the machine direction 116 of the conveyor 110 may pass the glass tubes 102 through the beam path of the separating laser beam 132. The separating laser beam 132 may be incident on the target regions 190 of the glass tubes 102, which may cause heating of the glass in the target regions 190 of the glass tubes 102. As the separating laser beam 132 heats the target regions 190 of the glass tubes 102, a pulling force F may be applied to the first end 107 of the glass tube 102. In embodiments, the axial separation conveyor 180 may exert the pulling force F on the end of the glass tube (i.e., the first end 107 in FIG. 8). The axial separation conveyor 180 may exert the pulling force F on the end of the glass tube 102 by following a path that diverges away from the conveyor 110 such that contact between the glass tube 102 and the surfaces of the axial separation conveyor 180 near the first end 107 of the glass tube 102 exerts an axial pulling force on the first end 107 of the glass tube 102.

Applying the pulling force F to the at least one end of the glass tube 102 may convey the section 192 of the glass tube 102 away from the glass tube 102 in the axial direction relative to the center axis A of the glass tube 102, which may separate the section 192 from the glass tube 102. In particular, as the temperature of the glass in the target region 190 increases through operation of the separating laser beam 132, the glass in the target region 190 may become viscous, and application of the pulling force F to the first end 107 of the glass tube 102 may cause the a section 192 of the glass tube 102 to pull away from and separate from the rest of the glass tube 102 at the target region 190. The section 192 may be large enough for the axial separation conveyor 180 or other device to produce enough pulling force F to separate the section 192 from the glass tube 102. In embodiments, the section 192 removed from the at least one end of the plurality of glass tubes 102 have an axial length of less than about 100 mm, such as from about 13 mm to about 100 mm, or from about 10 mm to about 100 mm.

During separation, at the target region 190, the glass thins and stretches out until the glass separates. Once separated, surface tension within the glass may cause the volumes of viscous glass on either side of the separation point to flow back to the new end 196 of the glass tube 102 and the end of the section 192, respectively. In embodiments, the volume of heated glass may be great enough so that the viscous glass flowing back to the new end 196 of the glass tube 102 may form a meniscus over the new end 196 of the glass tube 102. Forming a meniscus of glass over the new end 196 of the glass tube 102 may seal the new end 196 of the glass tube 102. In embodiments, the volume of glass heated by the separating laser beam 132 in the target region 190 may not be sufficient to form a meniscus, resulting in a new end 196 of the glass tube 102 that is open, as shown in FIG. 8.

The characteristics of the separating laser beam 132, such as but not limited to beam shape, power density, power density distribution, or combinations thereof, may be modified to transition the system 100 from producing the new end 196 of the glass tube 102 that is open to producing the new end 196 of the glass tube 102 that is sealed. The characteristics of the separating laser beam 132 may also be modified to adjust the heating rate, such as for responding to changes in the type of glass tube 102 (e.g., changes in glass composition, nominal diameter, average wall thickness, etc.) or to adjust for changes to the production rate. Modifying the characteristics of the separating laser beam 132 will be discussed in further detail herein.

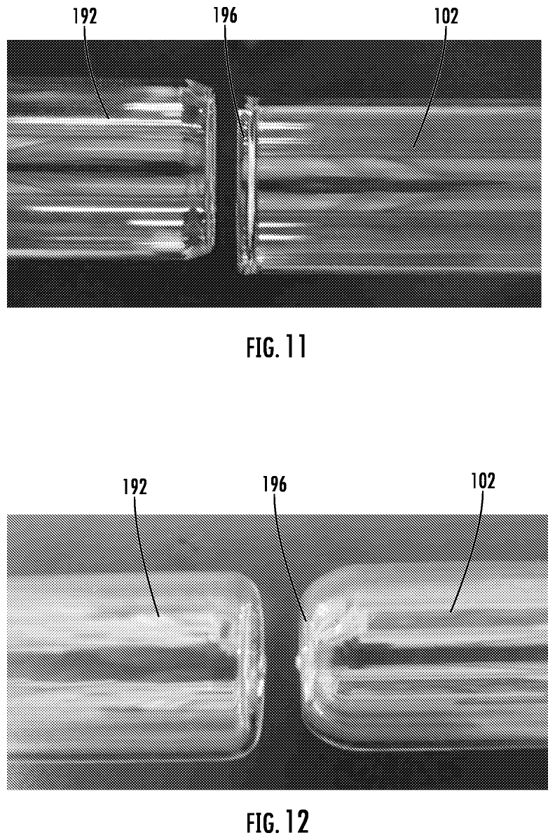

In embodiments, finishing the end of the glass tube 102 may produce the new end 196 that is an open end of the glass tube 102, such as having an opening therethrough. FIG. 11 shows a photograph of new ends 196 of the glass tube 102 that are open following separation of the annular section 192 from the end of the glass tube 102. In embodiments, finishing the end of the glass tube 102 may seal the new end 196 of the glass tube 102 to produce a sealed end of the glass tube 102. FIG. 12 shows a photograph of the new ends 196 of the glass tubes 102 that are sealed following separation of the annular segment from end of the glass tube 102. Regardless of whether the new end 196 is sealed or open, the heating of the glass by the separating laser beam and separation of the section 192 from the end of the glass tube 102 may produce the new end 196 that is already polished and finished, as shown in FIGS, 11 and 12. The finish provided by heating with the separating laser beam and flow back of viscous glass after separation of the section 192 from the end of the glass tube 132 may be equivalent to or better than a finish provided by fire polishing the end, according to conventional methods.

In embodiments, the new end 196 of the glass tube 102 resulting from operation of the system may be substantially free of surface defects, such as but not limited to cracks, scratches, or any other surface inclusions. In embodiments, the new ends 196 of the glass tubes 102 resulting from the systems and methods disclosed herein may have an Acceptable Quality Level of less than 0.25 for end cracks having a crack length of greater than 2 mm. Acceptable Quality Level (AQL) is defined according to ISO 2859-1. End cracks refer to cracks appearing in the axial ends of the glass tubes. In embodiments, the new ends 196 of the glass tubes 102 resulting from the systems and methods disclosed herein may have an AQL of less than or equal to 0.025 for surface cracks of any size and any length. Surface cracks refer to cracks in the outer surface and/or inner surface of the glass tubes 102 (i.e., not the end surfaces). In embodiments, the new end 196 of the glass tube 102 and/or the entirety of the glass tube 102, following finishing the ends by separation of the section 192 using the separating laser beam, may be substantially free of fused glass particles, hydrocarbon combustion products, or both. In embodiments, the glass tubes 102 have zero glass particles having a diameter of greater than 0.5 mm attached to the inner surfaces or outer surfaces of the glass tubes 102. In embodiments, the glass tubes 102 may have less than or equal to 5 glass particles having diameters from 0.2 mm to less than 0.5 mm attached to the inner surfaces or outer surfaces of the glass tubes 102. In embodiments, the glass tubes 102 produced by the systems and methods disclosed herein may have an AQL of less than 0.1 for impurities measuring greater than 1 mm that are on the outer surfaces of the glass tubes and are not easily removed. In embodiments, the glass tubes 102 produced by the systems and methods disclosed herein may have an AQL of less than 0.1 for impurities measuring greater than 0.5 mm that are on the inner surfaces of the glass tubes and are not easily removed. In embodiments, the glass tubes 102 produced by the systems and methods disclosed herein may be free of discoloration of the glass tube, visual deposits on the surfaces of the glass tube, or both caused by deposition of combustion products onto the surfaces of the glass tubes.

Referring again to FIG. 8, removal of the section 192 from the first end 107 of the glass tube 102 may finish the end of the glass tube 102 by reducing a length of the glass tube 102 to the final length of the glass tube 102 and by providing a new end that is finished and polished. The system 100 of the present disclosure may accomplish reducing the length of the glass tube 102 to the final length and providing a finished new end of the glass tube 102 in the single step of removing the section 192 from the end of the glass tube 102, which is accomplished by directing the separating laser beam 132 at the target region 190 of the glass tube 102 while also applying the pulling force F to the end of the glass tube 102 at the same time

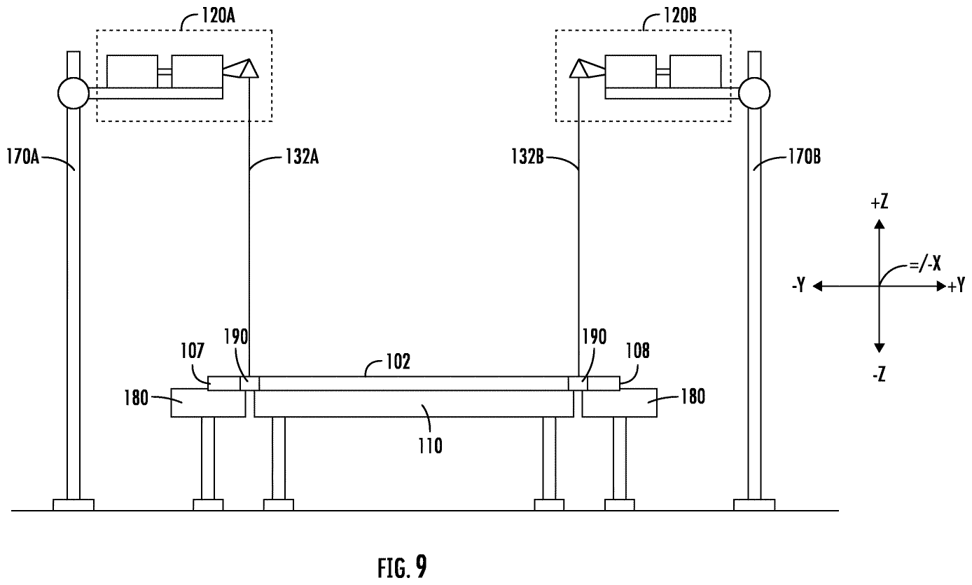

The second end 108 of the glass tube 102 may be cut and finished using the same method described for cutting and finishing the first end 107 of the glass tube 102. Referring now to FIG. 9, in embodiments, the system 100 may include a separating laser system 120 for each end of the glass tube 102. In embodiments, the system 100 may include a first separating laser system 120A and a second separating laser system 120B. The first separating laser system 120A and the second separating laser system 120B may have any of the components and/or features previously discussed for the separating laser system 120. The first separating laser system 120A may comprise a first laser source and a first beam delivery system, and the second separating laser system 120B may comprise a second laser source and a second beam delivery system, both of which may be the same or different from the first laser source and first beam delivery system, respectively. The first separating laser system 120A may be operable to direct a first separating laser beam 132A to target regions 190 proximate first ends 107 of the plurality of glass tubes 102. The second separating laser system 120B may be operable to direct a second separating laser beam 132B to target regions 190 proximate to second ends 108 of the plurality of glass tubes 102. The first separating laser beam 132A and the second separating laser beam 132B may each have any of the features and/or characteristics previously discussed herein for the separating laser beam 132.

In embodiments, the system 100 may further include a first laser system positioner 170A and a second laser system positioner 170B, which may each have any of the features and/or components previously described herein for the laser system positioner 170. The first laser system positioner 170A may be operable to position the first separating laser system 120A relative to the glass tubes 102, and the second laser system positioner 170 may be operable to position the second separating laser system 120B relative to the glass tubes 102. In embodiments, the system 100 may include a single laser system positioner 170, which may support and position both the first separating laser system 120A and the second separating laser system 120B.

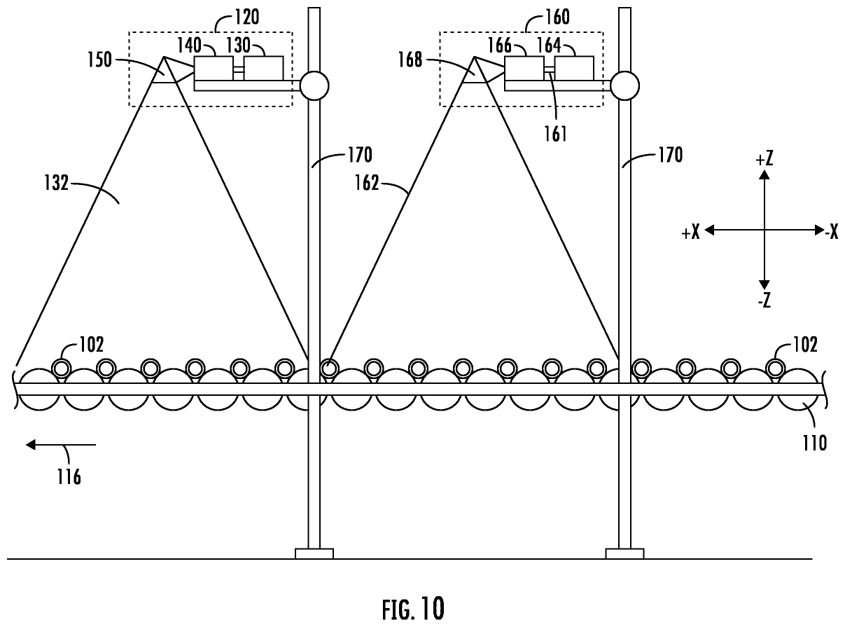

Referring now to FIG. 10, in embodiments, the system 100 may further include a preheating laser system 160 disposed upstream from the separating laser system 120. In some instances, the properties of the glass tube 102, such as the type of glass composition, average wall thickness, nominal diameter, or combinations thereof, may require additional heating to accomplish separation of the sections 192 from the ends of the glass tubes 102. Additionally, use of the preheating laser system 160 may enable increasing the separation rate, and thus the production rate of the finishing process, which can enable increasing the draw speed of the process for making the continuous hollow glass cylinder.

As shown in FIG. 10, the preheating laser system 160 may be disposed upstream of the separating laser system 120. The preheating laser system 160 may be operable to produce a preheating laser beam 162 and direct the preheating laser beam 162 towards the glass tubes 102. The preheating laser system 160 may include a preheating laser source 164 and a preheating beam delivery system 166. The preheating laser system 160 may further include a turning mirror 168. The preheating laser source 164, the preheating beam delivery system 166, and the turning mirror 168 may have any of the features previously described herein for the separating laser source 130, the beam delivery system 140, and the turning mirror 150. The preheating laser source 164 may be operable to produce the laser beam 161. The preheating beam delivery system 166 may be operable to modify a shape, power density, power density distribution, or other characteristic of the laser beam 161 to produce the preheating laser beam 162. The turning mirror 168 may be operable to direct the preheating laser beam 162 towards the target regions of the glass tubes 102 at a position upstream of the separating laser beam 132 (i.e., a position in the −X direction of the coordinate axis in FIG. 10 relative to the position of the separating laser beam 132). The preheating laser beam 162 may have any of the features, properties, or characteristics previously described herein for the separating laser beam 132.

During operation of the system 100, the conveyor 110 may move the glass tubes 102 through the beam path of the preheating laser beam 162. The preheating laser beam 162 may heat the target regions of the glass tubes 102 through contact of the preheating laser beam 162 with the outer surface of the glass tubes 102. The conveyor 110 may then pass the glass tubes 102 out of the beam path of the preheating laser beam 162 and into the beam path of the separation laser beam 132, which may complete the heating and separation of the annular section from the end of the glass tubes 102.

In embodiments, the system 100 may include a plurality of preheating laser systems 160. In embodiments, the system 100 may include a preheating laser system 160 disposed upstream from each of the separating laser systems 120 (i.e., one for each end of the glass tubes 102). In embodiments, the system 100 may include a first preheating laser system disposed upstream of the first separating laser system 120A (FIG. 9) and a second preheating laser system disposed upstream of the second separating laser system 120B (FIG. 9). In embodiments, the system 100 may include a plurality of preheating laser systems 160 disposed in series upstream of each of the separating laser systems 120. Referring again to FIG. 10, in embodiments, each of the preheating laser systems 160 may include one of the laser system positioners 170, which may be operable to position the preheating laser system 160 in the +/−Z direction of the coordinate axis in FIG. 10 (e.g., in the vertical direction). The laser system positioner 170 may be operable to change a distance in the +/−Z direction between the preheating laser system 160 and the glass tubes 102 to change one or more characteristics of the preheating laser beam 162, such as but not limited to the power density or shape at the point where the preheating laser beam 162 contacts the glass tubes 102.

In embodiments, the systems 100 for cutting and finishing the ends of the glass tubes 102 do not include gas burners. In embodiments, the systems 100 for cutting and finishing the ends of the glass tubes 102 do not include any mechanical tools for scoring a surface of the plurality of glass tubes 102.

Referring again to FIGS. 3 and 8, methods for producing glass tubes 102 using the systems 100 disclosed herein will now be described in further detail. Referring now to FIG. 3, methods of the present disclosure for producing the glass tubes 102 may comprise producing the continuous hollow glass cylinder 222 or the annealed continuous hollow glass cylinder 242, cutting the continuous hollow glass cylinder 222 or annealed continuous hollow glass cylinder 242 into a plurality of individual glass tubes 102 having an initial length, and finishing at least one end (e.g., first end 107, second end 108, or both) of the plurality of glass tubes 102. Referring now to FIG. 8, finishing the ends of the glass tubes 102 comprises rotating each glass tube 102 about the center axis A of the glass tube 102; while rotating the glass tube 102, heating the target region 190 of the glass tube 102 by exposing the target region 190 to the separating laser beam 132; and while exposing the target region 190 of the glass tube 102 to the separating laser beam 132, applying a pulling force F to the at least one end (e.g., first end 107 in FIG. 8) of the glass tube 102. Applying the pulling force F while exposing the target region 190 to the separating laser beam 132 may separate an annular section 192 of the glass tube 102 from the end of the glass tube 102 to produce a new end 196 of the glass tube 102 and may finish the new end 196 of the glass tube 102.

Finishing the ends of the glass tubes 102 reduces a length of the glass tube 102 to a final length. In embodiments, finishing the ends of the glass tubes 102 using the separating laser beam 132 may produce the new ends 196 that are polished and exhibit minimal surface defects. In embodiments, the new ends 196 of the glass tubes 102 may be substantially free of surface defects. In embodiments, the new ends 196 of the glass tubes 102 may be substantially free of fused glass particles, hydrocarbon combustion products, or both. In embodiments, finishing the ends of the glass tubes 102 may comprise forming the new ends 196 of the glass tubes 102 that are open ends, such as having an opening therethrough. In embodiments, finishing the ends of the glass tubes 102 may seal the new ends 196 of the glass tubes 102 to produce sealed new end of the glass tube 102. Finishing the ends of the glass tube 102 may comprise heating a volume of glass in the target region 190 sufficient to form a meniscus of glass over each new end 196 of each glass tube 102 during separation of the sections 192 from the ends of the glass tubes 102.

Referring to FIG. 8, exposing each of the plurality of glass tubes 102 to the separating laser beam 132 may comprise producing the laser beam 131 using the laser source 130, passing the laser beam 131 through the beam delivery system 140, which comprises optics that modify the shape or properties the laser beam 131 to produce the separating laser beam 132 and direct the separating laser beam 132 towards the plurality of glass tubes, and passing each of the plurality of glass tubes 102 through the beam path of the separating laser beam 132. In embodiments, passing each of the glass tubes 102 through the beam path of the separating laser beam 132 may further comprise conveying the plurality of glass tubes horizontally (i.e., in the +X direction of the coordinate axis of FIG. 8) through the beam path of the separating laser beam 132 while rotating the glass tubes 102.

In embodiments, applying the pulling force F to the end of the glass tube 102 may convey the section 192 of the glass tube 102 away from the glass tube 102 in the axial direction relative to the center axis A of the glass tube 102. Conveying the section 192 axially away from the glass tube 102 may separate the section 192 from the glass tube 102. In embodiments, the pulling force F may be applied in a cross-machine direction (i.e., the +/−Y direction of the coordinate axis in FIG. 8), where the cross-machine direction is parallel to the center axis A of the glass tubes 102 and perpendicular to the horizontal travel direction of the conveyor 110 (e.g., in the +X direction of the coordinate axis in FIG. 8). Applying the pulling force F to the ends of the glass tubes 102 may comprise providing one or more of the axial separation conveyors 180, each of which may be positioned to support an end of the glass tube 102 and may diverge from the conveyor 110 along path 181. Contact between the glass tubes 102 and the rollers of the axial separation conveyor 180 and divergence of the axial separation conveyors 180 from the conveyor 110 along path 181 may exert the pulling force F on the end of the glass tube 102 in the axial direction (e.g., +/−Y direction).

Referring now to FIG. 9, in embodiments, the methods disclosed herein may include finishing both ends of the glass tube 102. In particular, the methods may include finishing the first end 107 of each of the plurality of glass tubes 102 with a first separating laser beam 132A and finishing a second end 108 of each of the plurality of glass tubes 102 with a second separating laser beam 132B. In embodiments, the methods may include finishing the first end 107 and the second end 108 of each of the plurality of glass tubes 102 in parallel. In embodiments, the methods may comprise finishing the second end 108 with the second separating laser beam 132B downstream of finishing the first end 107 with the first separating laser beam 132A.

Referring again to FIG. 8, in embodiments, the methods may include processing a plurality of glass tubes 102 at one time. In embodiments, the separating laser beam 132 may be an elongated beam, and the methods may comprise exposing the target regions 190 of a subset of the plurality of glass tubes 102 to the separating laser beam 132 simultaneously. In embodiments, the separating laser beam 132 may have the ratio of the overall length to the beam width of from about 5 to about 2000 at a point along a beam path where the separating laser beam 132 falls incident on outer surfaces of the subset of the glass tubes 102. In embodiments, exposing the target regions 190 of the plurality of glass tubes 102 to the separating laser beam 132 may comprise conveying each of the plurality of glass tubes 102 in succession through the elongated beam of the separation laser beam 132 from the leading edge 154 to the trailing edge 156 of the separating laser beam 132. Conveying each of the plurality of glass tubes 102 through the overall length of the separating laser beam 132 may gradually heat the glass at the target regions 190 and may separate the section 192 from the end of each of the plurality of glass tubes 102, when the pulling force F is applied. The overall length of the separating laser beam 132 may be sufficient to contact each of the subset of glass tubes 102 simultaneously. In embodiments, conveying each of the plurality of glass tubes 102 in succession through the elongated beam of the separating laser beam 132 may comprise arranging the plurality of glass tubes 102 side-by-side on the conveyor 110 comprising the plurality of rollers 112 and at least one belt, where each glass tube 102 is disposed between two adjacent rollers 112 of the conveyor 110. The rollers 112 of the conveyor 110 may rotate each of the plurality of glass tubes 102, and the at least one belt may move the rollers 112 and the plurality of glass tubes 102 horizontally (i.e., in the +X direction of the coordinate axis in FIG. 8) through the separating laser beam 132.

Referring now to FIG. 10, in embodiments, the methods disclosed herein may further include preheating the target regions 190 of the glass tubes 102 prior to exposing the target regions of the glass tubes 102 to the separating laser beam 132. Preheating the target regions 190 of the glass tubes 102 may comprise rotating each of the glass tubes 102 and exposing each of the glass tubes 102 to a preheating laser beam 162 disposed upstream of the separating laser beam 132. The preheating laser beam 162 may be separate from the separating laser beam 132. The methods may further include changing a distance between the preheating laser system 160 and the glass tubes 102 to change a shape or power density of the preheating laser beam 162.

In embodiments, the methods disclosed herein may also comprise changing a heating rate of the separating laser beam 132. Changing the heating rate of the separating laser beam 132 may comprise changing the power density of the separating laser beam 132, changing the power density distribution of the separating laser beam 132, changing the speed of the conveyor 110 that translates the plurality of glass tubes 102 through the separating laser beam 132, or combinations thereof. In embodiments, changing the heating rate of the separating laser beam 132 may comprise changing the power density of the separating laser beam 132 at the point along the beam path where the separating laser beam 132 contacts the glass tube 102. In embodiments, changing the power density of the separating laser beam 132 at the point where the separating laser beam 132 contacts the glass tubes 102 may comprise adjusting a power of the laser source 130 for producing the laser beam 131, changing the distance between a beam delivery system 140 and the plurality of glass tubes 132, or both.

Referring to FIG. 7, in embodiments, changing the power density of the separating laser beam 132 at the point where the separating laser beam 132 contacts the glass tubes 102 comprises changing the distance D_{L} between the separating laser system 120 and the glass tubes 102, which changes the position of the waist 158 of the separating laser beam 132 relative to the glass tubes 102. Changing the distance D_{L} to move the waist 158 closer to the glass tubes 102 may increase the power density of the separating laser beam 132 at the point where the separating laser beam 132 contacts the glass tubes 102. Conversely, changing the distance D_{L} to move the waist 158 further away from the glass tubes 102 may decrease the power density of the separating laser beam 132 at the point where the separating laser beam 132 contacts the glass tubes 102.

In embodiments, changing the heating rate of the separating laser beam 132 may comprise changing the power density distribution of the separating laser beam 132. Changing the power density distribution of the separating laser beam 132 may comprise passing the laser beam 131 through a cylindrical lens to produce a separating laser beam 132 having a Gaussian power density distribution, which has a lower heating rate, or passing the laser beam 131 through an aspheric-cylindrical lens to produce a separating laser beam 132 having a flat-top power density distribution, which has a greater heating rate. In embodiments, changing the heating rate of the separating laser beam 132 does not require changing the lenses of the beam delivery system 140.

Referring again to FIG. 10, in embodiments, the methods disclosed herein may comprise changing a heating rate of the preheating laser beam 162. Changing the heating rate of the preheating laser beam 162 may comprise changing the power density of the preheating laser beam 162, changing the power density distribution of the preheating laser beam 162, changing the speed of the conveyor 110 that translates the plurality of glass tubes 102 through the preheating laser beam 162, or combinations thereof. In embodiments, changing the heating rate of the preheating laser beam 162 may comprise changing the power density of the preheating laser beam 162 at the point along the beam path where the preheating laser beam 162 contacts the glass tube 102. In embodiments, changing the power density of the preheating laser beam 162 at the point where the preheating laser beam 162 contacts the glass tubes 102 may comprise adjusting a power of the preheating laser source 164 for producing the preheating laser beam 162, changing the distance between a preheating beam delivery system 166 and the plurality of glass tubes 132, or both, which may be similar to the methods of changing the power density of the separation laser beam 132 previously discussed. In embodiments, changing the heating rate of the preheating laser beam 162 may also include changing the power density distribution, such as by using a cylindrical lens to produce a Gaussian distribution having a lower heating rate or an aspheric-cylindrical lens to produce a flat-top power density distribution having a greater heating rate. In embodiments, changing the heating rate of the preheating laser beam 162 does not require changing the lenses of the preheating beam delivery system 166.

The methods disclosed herein may be modified to finish the new ends 196 of the glass tubes 102 so that the new ends 196 are open or sealed. In embodiments, finishing the ends of the glass tubes 102 may comprise forming new ends 196 that are open ends, meaning that the new ends 196 of the glass tubes 102 are annular. In embodiments, the separating laser beam 132 may have a beam width of from 0.5 mm to 5 mm at the point along a beam path where the separating laser beam 132 falls incident on outer surfaces of the plurality of glass tubes 132, and exposing each of glass tubes 102 to the separating laser beam 132 may remove the annular section 192 from the end of each glass tube 102 to produce the new end comprising an opening. To form open ends on the glass tubes 102, the beam width of the separating laser beam 132 may be reduced, which decreases the volume of glass that is heated during separation of the annular section 192 from the end of the glass tube 102. The decreased volume of glass resulting from reducing the beam width of the separating laser beam 132 may not be sufficient to form a stable meniscus across the end of the glass tube 102, which results in surface tension forces causing the viscous heated glass to flow back to the sidewalls at the new end 196 of the glass tubes 102 after the annular sections are separated from the glass tubes 102. This results in the new end 196 being an open end.

In embodiments, finishing the ends of the glass tubes 102 may comprise forming new ends 196 that are sealed ends, meaning that the new end 196 is enclosed or covered over by a film or wall of glass. Finishing the ends of the glass tube 102 may seal the new end 196 of the glass tube 102 to produce a sealed end of the glass tube. In embodiments, the separating laser beam 132 may have a beam width of from about 3 mm to 20 mm at the point along a beam path where the separating laser beam 132 falls incident on outer surfaces of the glass tubes 102, and exposing each of the glass tubes 102 to the separating laser beam 132 may remove the annular sections 192 from the ends of the glass tubes 102 to produce the new end 196 and seals the new end 196 to produce a sealed end of the glass tube 102. To form sealed ends on the glass tubes 102, the beam width of the separating laser beam 132 may be increased, which increases the volume of glass that is heated during separation of the annular section 192 from the end of the glass tube 102. The increased volume of glass resulting from increasing the beam width of the separating laser beam 132 may be sufficient to form a stable meniscus of glass across the end of the glass tube 102. The volume of glass in the meniscus of glass formed over the end may be sufficient to resist surface tension forces, which results in the meniscus covering the new end 196 of the glass tube 102 and cooling to form the sealed end of the glass tube 102.

The methods disclosed herein may include adjusting the system 100 to switch between forming open ends and forming sealed ends of the glass tube 102. In embodiments, the methods may include determining whether to finish the ends of the glass tubes 102 to produce open or sealed new ends and changing one or more of the beam shape (e.g., beam width), power, power density distribution, or combinations thereof of the separating laser beam 132. Changing the beam shape, power, power density distribution, or combination thereof of the separating laser beam 132 may change the volume of glass heated in the target regions 190 of the plurality of glass tubes 102. As previously discussed, decreasing the volume of glass heated in the target regions 190 may produce the new ends with an opening, and increasing the volume of glass heated in the target regions 190 may produce a meniscus of glass that seals the new ends 196 when the annular sections 192 are removed from the ends of the glass tubes 102.

Changing the beam shape may comprise adjusting the spacing between two or more lenses of the beam delivery system 140, adjusting the distance between the beam delivery system 140 and the plurality of glass tubes 102, or combinations of these. In embodiments, changing the beam shape may comprises adjusting the distance between the beam delivery system 140 and the glass tubes 102, which changes a point within a beam path where the separating laser beam 132 contacts outer surfaces of the plurality of glass tubes 102 relative to the waist 158 of the separating laser beam 132. In embodiments, transitioning between forming open ends and forming sealed ends may comprise changing the power density of the separating laser beam 132 at the point along a beam path where the separating laser beam 132 contacts outer surfaces of the glass tubes 102. Changing power density of the separating laser beam 132 where it contacts the glass tubes 102 may comprise adjusting the power of the laser source 130 for producing the separating laser beam 132, changing the distance between the beam delivery system 140 and the plurality of glass tubes 102, or both. For producing sealed ends, the method may include adjusting the distance between the beam delivery system 140 and the glass tubes 102 to move the waist 158 of the separating laser beam 132 closer to the glass tubes 102, which may increase the power density of the separating laser beam 132 at the point where the separating laser beam 132 contacts the glass tubes 102. For producing open ends, the method may include adjusting the distance between the beam delivery system 140 and the glass tubes 102 to move the waist 158 of the separating laser beam 132 farther away from the glass tubes 102, which may decrease the power density of the separating laser beam 132 at the point where the separating laser beam 132 contacts the glass tubes 102.

In embodiments, the methods may include transitioning from forming the new ends 196 that are open to forming the new ends that are sealed, wherein the transitioning comprises one or more of the following: increasing the beam width of the separating laser beam 132; increasing the power density of the separating laser beam 132; changing the power density distribution of the separating laser beam 132 from a Gaussian power density distribution to a flat-top power density distribution; or combinations thereof. In embodiments, transitioning between forming the new ends that are open to forming the new ends that are sealed may comprise heating a volume of glass sufficient to form a meniscus of glass over the new end of the plurality of glass tubes when the section is removed from the at least one end of the plurality of glass tubes. In embodiments, transitioning from forming new ends that are open to forming new ends that are sealed may comprise changing the beam shape of the separating laser beam 132 by increasing the beam width into a range of from 3 mm to 20 mm.

In embodiments, the methods may include transitioning from forming the new ends 196 that are sealed to forming the new ends that are open, wherein the transitioning comprises one or more of the following: decreasing the beam width of the separating laser beam 132; decreasing the power density of the separating laser beam 132; changing the power density distribution of the separating laser beam 132 from a flat-top power density distribution to a Gaussian power density distribution; or combinations thereof. In embodiments, transitioning between forming the new ends that are sealed to forming the new ends that are open may comprise reducing the volume of glass heated in the target region to prevent formation of a meniscus of glass over the new end of the plurality of glass tubes when the section is removed from each of the glass tubes. In embodiments, transitioning from forming new ends that are sealed to forming new ends that are open may comprise changing the beam shape of the separating laser beam 132 by decreasing the beam width into a range of from 0.5 mm to 5 mm.

Transitioning between forming open ends and forming sealed ends may also include modifying the properties of the preheating laser beam 162, when the system 100 includes the preheating laser system 160. In embodiments, transitioning between forming open ends and forming sealed ends may comprise changing one or more of the beam shape (e.g., thickness), power, power density distribution, or combinations thereof of the preheating laser beam 162. Changing the beam shape, power, power density distribution, or combination thereof of the preheating laser beam 162 may change the volume of glass heated in the target regions 190 of the plurality of glass tubes 102.

Referring again to FIGS. 8 and 10, the methods of the present disclosure may include changing a type of the glass tube 102 from a first type of glass tube 102 to a second type of glass tube 102 and changing the heating rate of the separation laser beam 132, the preheating laser beam 162, or both in response to the change in the type of glass tube 102. Changing the type of glass tube 102 from a first type of glass tube to a second type of glass tube can include changing a glass composition, a nominal diameter, a sidewall thickness, or combinations thereof of the plurality of glass tubes 102 produced by the glass tube forming process. The heating rate of the separating laser beam 132, the preheating laser beam 162, or both may be changed by any of the methods previously discussed herein. In embodiments, changing the heating rate of the separating laser beam 132, the preheating laser beam 162, or both may include changing the power density of the separating laser beam 132, the preheating laser beam 162, or both; changing the power density distribution of the separating laser beam 132, the preheating laser beam 162, or both; changing a speed of the conveyor 110 that translates the plurality of glass tubes 102 through the separating laser beam 132 or the separating laser beam 132 and the preheating laser beam 162; or combinations thereof. In embodiments, changing the heating rate of the separating laser beam 132, the preheating laser beam 162, or both does not require changing the lenses of the beam delivery system 140 or the preheating beam delivery system 166.

The systems and method of the present disclosure may enable increasing the production rate of the glass tube forming process. The methods disclosed herein can include increasing a production rate of the system 100 for cutting and finishing the ends of the glass tubes 102, which may enable the production rate of the tube forming process as a whole to be increased. In embodiments, increasing the production rate of the system 100 for cutting and finishing the ends of the glass tubes 102 may comprise increasing a speed of the conveyor 110 that translates the plurality of glass tubes 102 through a beam path of the separating laser beam 132, and increasing a heating rate of the separating laser beam 132, the preheating laser beam 162, or both. The heating rate of the separating laser beam 132, the preheating laser beam 162, or both may be changed by any of the methods previously discussed herein. In embodiments, increasing the heating rate of the separating laser beam 132, the preheating laser beam 162, or both may include increasing the power density of the separating laser beam 132, the preheating laser beam 162, or both; changing a power density distribution of the separating laser beam 132, the preheating laser beam 162, or both from a Gaussian power density profile to a flat-top power density profile; or a combination thereof. In embodiments, increasing the production rate of the system 100 for cutting and finishing the ends of the glass tubes 102 may comprise preheating the target regions of the glass tubes 102 with the preheating laser system 160.

Referring again to FIGS. 3 and 4, methods disclosed herein for producing glass tubes 102 can comprise producing the continuous hollow glass cylinder 222, cutting the continuous hollow glass cylinder 222 into the plurality of glass tubes 102, and finishing the ends of the glass tubes 102. Producing the continuous hollow glass cylinder may comprise drawing the continuous hollow glass cylinder from the tube forming apparatus 220. In embodiments, producing the continuous hollow glass cylinder may include forming the continuous hollow glass cylinder 222 from molten glass in a tube forming apparatus 220, pulling the continuous hollow glass cylinder 222 from the tube forming apparatus 220 through the annealing section 240; annealing the continuous hollow glass cylinder 222 in the annealing section 240 to produce an annealed continuous hollow glass cylinder 242; cutting the annealed continuous hollow glass cylinder 242 to produce the plurality of glass tubes 102 having an initial length; and transferring the plurality of glass tubes 102 to the conveyor 110 of the system 100 for finishing the ends of the glass tubes 102.

The systems and methods disclosed herein may also be applied to cut and finish the ends of glass rods. In particular, the systems 100 disclosed herein having the conveyor 110 and the separating laser system 120, as well as any of the preheating laser systems 160, axial separation conveyors 180, or combinations of these, may be used to cut and finish the ends of glass rods downstream of a glass rod forming process. When cutting and finishing glass rods, the system 100 may have any of the components or features previously discussed herein in association with cutting and finishing glass tubes.

Products in pharmaceutical packaging such as but not limited to vials, cartridges, syringes, ampoules, jars, or other containers are converted from the glass tubing, such as the glass tubing produced from the systems and methods previously discussed herein. In the converting process, the glass tubes are indexed through a variety of stations, at which heating and forming contacts are applied to transform glass tubing into the final products, which are glass articles. The laser systems and methods disclosed herein can be further incorporated into the converting process for producing glass articles from the glass tubes. In particular, the laser systems, such as the separating laser system and/or the preheating laser system can be incorporated into a converting process in place of one or more gas burners to heat the glass prior to forming or to separate partially formed glass articles from the working end of the glass tubes. The laser systems and methods disclosed herein can enable formation of infra-red laser beams with different shapes and spatial power distribution. In addition, superposition of the beams and control of the exposure time of the glass articles and glass tubes to the laser beams can allow for precise energy delivery to the glass, can enable targeted heat and stress pattern manipulations by operator's choice to enhance accuracy and repeatability of the process and, as a result, quality of the final product. An experimental platform composed of multiple laser modules integrated with tube handling equipment can be used to model the use of the laser systems and methods on a glass tube converter for making glass articles from the glass tubes. Additionally, in embodiments, the converting process may be a hybrid converting process that includes a combination of gas burners with laser-assisted heating.

A method for producing glass articles from the glass tubes may comprise rotating the glass tube about a center axis of the glass tube; while rotating the glass tube, heating a target region of the glass tube to a forming temperature, wherein the target region may be proximate a working end of the glass tube; after heating the target region of the glass tube, forming at least one feature of the glass article at the target region of the glass tube, while rotating the glass tube; and separating the glass article from the working end of the glass tube at a separating region of the glass tube. Heating the target region of the glass tube, separating the glass article from the working end of the glass tube, or both may comprise exposing the target region, the separating region, or both of the glass tube with a laser beam having a wavelength in a range of from about 1 μm to about 12 μm. Exposing the target region, the separating region, or both to the laser beam may heat the glass at the target region, the separating region, or both to a temperature of greater than or equal to about 1000° C.

In embodiments, heating the target region of the glass tube may comprise exposing the target region to the laser beam, wherein the laser beam may be a heating laser beam. In embodiments, the heating laser beam may have a circular cross section. In embodiments, the heating laser beam may have a Gaussian power density distribution.

In embodiments, separating the glass article from the working end of the glass tube may comprise exposing the separating region of the glass tube to the laser beam, wherein the laser beam may be a separating laser beam. In embodiments, separating the glass article from the working end of the glass tube may comprise applying a pulling force to the glass article while exposing the separating region of the glass tube to the laser beam, wherein the pulling force may move the glass article away from the glass tube in an axial direction relative to the center axis of the glass tube. In embodiments, the glass tube may be oriented vertically with the working end of the glass tube facing downward, and the pulling force may comprise the force of gravity. In embodiments, the separating laser beam may have an elliptical cross section with a major axis and a minor axis.

In embodiments, separating the glass article from the working end of the glass tube further may comprise forming an open end on a bottom of the glass article where the bottom of the glass article may be the end of the glass article previously coupled to the glass tube prior to separation. In embodiments, the separating laser beam may have a beam width of from about 0.5 mm to about 5 mm. In embodiments, the separating laser beam may have a beam length of from about 20 mm to about 35 mm. In embodiments, the separating laser beam may be an elliptical beam having a ratio of major axis to minor axis of from about 4 to about 70.

In embodiments, separating the glass article from the working end of the glass tube further may comprise forming a thin bottom of the glass article. In embodiments, the separating laser beam may have a beam width of from about 5 mm to about 10 mm. In embodiments, the separating laser beam may be an elliptical beam having a ratio of major axis to minor axis of from about 2 to about 7. In embodiments, separating the glass article from the working end of the glass tube further may comprise forming thick bottom of the glass article. In embodiments, the separating laser beam may have a beam width of from about 3 mm to about 7 mm. In embodiments, the separating laser beam may be an elliptical beam having a ratio of major axis to minor axis of from about 2.5 to about 12. In embodiments, the separating laser beam may be an elliptical beam, and a major axis of the separating laser beam may be parallel to the center axis of the glass tube.

In embodiments, heating the target region of the glass tube, separating the glass article from the working end of the glass tube, or both may comprise exposing the target region, the separating region, or both of the glass tube with a first laser beam; and at the same time, exposing the target region, the separating region, or both of the glass tube with a second laser beam, wherein the first laser beam and the second laser beam may be superimposed on the target region or the separating region of the glass tube. In embodiments, the first laser beam may have a circular beam cross-section, and the second laser beam may have an elliptical beam cross-section. In embodiments, the method may comprise modifying an axial position of the second laser beam relative to an axial position of the first laser beam.

In embodiments, the method further may comprise finishing a bottom of the glass article, wherein the bottom of the glass article may comprise the end of the glass article formed from separation of the glass article from the working end of the glass tube. In embodiments, finishing the bottom of the glass article may comprise exposing the bottom of the glass article to a finishing laser beam. In embodiments, forming may comprise contacting a surface of the glass tube in the target region with one or more forming tools while rotating the glass tube, wherein contact between the forming tools and the surface of the glass tube changes a shape of the glass tube in the target region.

In embodiments, the methods may include operating a converter to produce a plurality of glass articles from a plurality of glass tubes. The converter may comprise a plurality of processing stations comprising at least one heating station, at least one forming station, and a separating station. Operating the converter may comprise translating each of the plurality of glass tubes through each of the plurality of processing stations in succession. The at least one heating station, the at least one separating station, or both may comprise exposing each of the glass tubes to the laser beam to heat each of the glass tubes at the target region, the separating region, or both.

In embodiments, the method further may comprise securing a glass tube in a holder of a converter comprising a plurality of processing stations, the plurality of processing stations comprising at least one heating station, at least one forming station, and a separating station, wherein the converter translates the holder and the glass tube successively through each of the processing stations. The method further may comprise forming one or more features of a glass article at a working end of the glass tube by translating the glass tube through the at least one heating station and the at least one forming station, and separating the glass article from the working end of the glass tube in the separating station. Heating the target region of the glass tube may comprise exposing the target region of the glass tube to the laser beam in the at least one heating station, or separating the glass article from the working end of the glass tube may comprise exposing the separating region of the glass tube with the laser beam in the separating station. In embodiments, the glass articles may be pharmaceutical containers. In embodiments, the pharmaceutical containers may comprise vials, syringes, cartridges, ampoules, or jars.

In embodiments, exposing the target region or the separating region of the glass tube to the laser beam may comprises producing the laser beam using a laser source, passing the laser beam through optics that modify a shape or power density distribution of the laser beam, and directing the laser beam towards the target region or separating region of the glass tubes. In embodiments, the laser beam may be a continuous laser beam or a pulsed laser beam. In embodiments, the laser beam may be collimated or un-collimated laser beam. In embodiments, the separating laser beam may comprise a laser power of from 50 W to 2000 W. In embodiments, the laser beam may be an elliptical beam or a round beam.

In embodiments, the methods may further include changing a shape of the laser beam, wherein changing the shape of the laser beam may change a volume of glass heated in the target region or the separating region of the glass tube. In embodiments, the methods further may comprise changing a power density distribution of the laser beam, wherein changing the power density distribution may change the heating rate of the laser beam. In embodiments, the methods further may include changing a power density of the laser beam, wherein changing the power density may change the heating rate of the laser beam. In embodiments, the methods may include controlling an exposure time of the glass tube to the laser beam during heating the target region of the glass tube, separating the glass article from the working end of the glass tube or both by adjusting the time at which a laser source for producing the laser beam is turned on and then off. In embodiments, exposing the target region, the separating region, or both of the glass tube may comprise superimposing two or more laser beams at one time at the target region, the separating region, or both.

In embodiments, the methods may include rotating the glass tubes at a rotational speed of from 60 rpm to 400 rpm. In embodiments, the laser beam may have a heating rate of from 200 ° C./second to 400 ° C./second. In embodiments, a converting rate of converting glass tubes to the glass articles may be greater than or equal to 30 parts per minute. In embodiments, heating the target region of the glass tube or separating the glass article from the working end of the glass tube may comprise exposing the glass tube to a gas burner to heat the glass. In embodiments, the target region may be within 50 mm of the working end of the glass tube.

In embodiments, a system for producing glass articles from glass tube may comprise a converter comprising a plurality of processing stations spaced apart in a circuit and at least one holder. The plurality of processing stations may comprise at least one heating station, at least one forming station, and a separating station. The at least one holder may be operable to hold a working end of the glass tube and rotate the glass tube about a center axis. The converter may be operable to translate the at least one holder having a glass tube secured therein through each of the plurality of processing station in succession. The system further may include at least one laser system disposed in the at least one heating station or the separating station. The at least one laser system may comprise a laser source and a beam delivery system. The laser system may be operable to generate a laser beam, modify one or more properties of the laser beam, and direct the laser beam at the glass tube in the at least one heating station of the separating station. The laser system may include any of the components, features, or characteristics previously described herein for the separating laser system 120. In embodiments, the at least one laser system may comprise a plurality of laser systems, wherein the plurality of laser systems may comprise at least one heating laser system disposed in the at least one heating station and a separating laser system disposed in the separating station.

While various embodiments of the systems 100 and methods for cutting and finishing the ends of the glass tubes 102 using the systems 100 have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method for producing glass tubes, the method comprising:
producing a continuous hollow glass cylinder;
cutting the continuous hollow glass cylinder into glass tubes having an initial length;
finishing at least one end of the plurality of glass tubes, wherein finishing the at least one end of the plurality of glass tubes comprises:
rotating each glass tube about a center axis of the glass tube;
while rotating the glass tube, heating a target region of the glass tube by exposing the target region of the glass tube to a separating laser beam; and
while exposing the target region of the glass tube to the separating laser beam, applying a pulling force to the at least one end of the glass tube, wherein applying the pulling force while exposing the target region to the separating laser beam separates a section of the glass tube from the at least one end of the glass tube and finishes a new end of the glass tube.

2. The method of claim 1, wherein the finishing the at least one end of the glass tube reduces a length of the glass tube to a final length and polishes the new end of the glass tube in a single manufacturing step.

3-4. (canceled)

5. The method of claim 1, wherein the new end of the glass tube is substantially free of surface defects.

6. The method of claim 1, wherein the new end of the glass tube is substantially free of fused glass particles, hydrocarbon combustion products, or both.

7-9. (canceled)

10. The method of claim 1, comprising finishing a first end of each of the plurality of glass tubes with a first separating laser beam and finishing a second end of each of the plurality of glass tubes with a second separating laser beam.

11-23. (canceled)

24. The method of claim 1, wherein the separating laser beam has a length of from about 100 mm to about 1000 mm, wherein the length of the separating laser beam is the distance from a leading edge to a trailing edge of the separating laser beam at a point along a beam path where the separating laser beam falls incident on outer surfaces of the plurality of glass tubes.

25. The method of claim 1, wherein the separating laser beam has a beam width of from about 0.5 mm to about 20 mm at a point along a beam path where the separating laser beam falls incident on outer surfaces of the plurality of glass tubes.

26-41. (canceled)

42. The method of claim 1, further comprising increasing a production rate of the glass tubes, wherein increasing the production rate of the glass tubes comprises changing a speed of a conveyor that translates the plurality of glass tubes through a beam path of the separating laser beam and increasing a power density of the separating laser beam, changing a power density profile from a Gaussian power density profile to a flat-top power density profile, or both.

43. The method of claim 42, wherein increasing the production rate of the glass tubes further comprises preheating the target regions of the plurality of glass tubes with a preheating laser system.

44. The method of claim 1, wherein target region of each glass tube is within at least 100 mm from the at least one end of the glass tube.

45-49. (canceled)

50. A system for finishing ends of a plurality of glass tubes or glass rods, the system comprising:
a conveyor operable to translate the plurality of glass tubes or glass rods horizontally while also rotating each of the plurality of glass tubes or glass rods about a center axis of the glass tube or glass rod;
a separating laser system comprising:
a laser source operable to produce a laser beam; and
a beam delivery system operable to modify a shape, power density, power density distribution, or combinations thereof of the laser beam to produce a separating laser beam and direct the separating laser beam to the plurality of glass tubes or glass rods being translated and rotated by the conveyor; and
one or more axial separation conveyors that diverge from the conveyor and are operable to exert a pulling force on an end of each of the plurality of glass tubes or glass rods in at least an axial direction relative to the center axis.

51-52. (canceled)

53. The system of claim 50, wherein the beam delivery system comprises at least one cylindrical lens operable to produce a separating laser beam with a Gaussian power density distribution.

54. The system of claim 50, wherein the beam delivery system comprises an aspheric-cylindrical lens operable to produce a beam having a flat-top power density distribution.

55. The system of claim 50, wherein the beam delivery system comprises a variable beam expander.

56. The system of claim 50, further comprising a preheating laser system disposed upstream of the separating laser delivery system, wherein the preheating laser system comprising a preheating laser source and a preheating beam delivery system and is operable to direct a preheating laser beam at the target regions of the plurality of glass tubes or glass rods to preheat the glass in the target regions upstream of the separating laser beam.

57. The system of claim 50, wherein the separating laser system comprises:
a first separating laser system operable to direct a first separating laser beam to target regions proximate first ends of the plurality of glass tubes or glass rods; and
a second separating laser system operable to direct a second separating laser beam to target regions proximate to second ends of the plurality of glass tubes or glass rods.

58. (canceled)

59. The system of claim 57, further comprising:
a first preheating laser system disposed upstream of the first separating laser system; and
a second preheating laser system disposed upstream of the second separating laser system, wherein each of the first preheating laser system and the second preheating laser system comprise a preheating laser source and a preheating beam delivery system.

60. The system of claim 50, further comprising a positioning system operatively coupled to the separating laser system, wherein the positioning system is operable to change a distance between the separating laser system and the plurality of glass tubes or glass rods.

61-62. (canceled)

63. The system of claim 50, wherein the system does not include gas burners and does not include mechanical tools for scoring a surface of the plurality of glass tubes or glass rods.

64-65. (canceled)

66. A method for producing glass rods, the method comprising:
producing a continuous solid glass cylinder;
cutting the continuous solid glass cylinder into glass rods having an initial length;
finishing at least one end of the plurality of glass rods, wherein finishing the at least one end of the plurality of glass rods comprises:
rotating each glass rod about a center axis of the glass rod;
while rotating the glass rod, heating a target region of the glass rod by exposing the target region of the glass rod to a separating laser beam; and
while exposing the target region of the glass rod to the separating laser beam, applying a pulling force to the at least one end of the glass rod, wherein applying the pulling force while exposing the target region to the separating laser beam separates a section of the glass rod from the at least one end of the glass rod and finishes a new end of the glass rod.
